(19) United States
(12) Patent Application Publication
(10) Pub. No.: US 2026/0046857 A1
(43) Pub. Date: Feb. 12, 2026

(54) REQUESTING BEAM CHARACTERISTICS SUPPORTED BY A USER EQUIPMENT FOR A PREDICTIVE BEAM MANAGEMENT

(71) Applicant: QUALCOMM Incorporated, San Diego, CA (US)

(72) Inventors: Qiaoyu LI, Beijing (CN); Hamed PEZESHKI, San Diego, CA (US); Mahmoud TAHERZADEH BOROUJENI, San Diego, CA (US); Tao LUO, San Diego, CA (US)

(21) Appl. No.: 19/099,682

(22) PCT Filed: Sep. 23, 2022
(86) PCT No.: PCT/CN2022/120738

§ 371 Date: Jan. 29, 2025

(51) Int. Cl. H04W 72/044; H04W 72/23

(52) U.S. Cl. CPC H04W 72/046; H04W 72/23

(57) ABSTRACT

Various aspects of the present disclosure generally relate to wireless communication. In some aspects, a user equipment (UE) may transmit, to a network node, a request that indicates one or more beam characteristics supported by the UE for a UE-based predictive beam management. The UE may receive, from the network node and based at least in part on the request, one or more of a downlink reference signal or an indication of a virtual resource, wherein the downlink reference signal or the virtual resource is associated with the one or more beam characteristics indicated in the request. Numerous other aspects are described.

### FIELD OF THE DISCLOSURE

Aspects of the present disclosure generally relate to wireless communication and to techniques and apparatuses for requesting beam characteristics supported by a user equipment (UE) for a predictive management.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: transmit, to a network node, a request that indicates one or more beam characteristics supported by the UE for a UE-based predictive beam management; and receive, from the network node and based at least in part on the request, one or more of a downlink reference signal or an indication of a virtual resource, wherein the downlink reference signal or the virtual resource is associated with the one or more beam characteristics indicated in the request.

In some implementations, an apparatus for wireless communication at a network node includes a memory and one or more processors, coupled to the memory, configured to: receive, from a UE, a request that indicates one or more beam characteristics supported by the UE for a UE-based predictive beam management; and transmit, to the UE and based at least in part on the request, one or more of a downlink reference signal or an indication of a virtual resource, wherein the downlink reference signal or the virtual resource is associated with the one or more beam characteristics indicated in the request.

In some implementations, a method of wireless communication performed by an apparatus of a UE includes transmitting, to a network node, a request that indicates one or more beam characteristics supported by the UE for a UE-based predictive beam management; and receiving, from the network node and based at least in part on the request, one or more of a downlink reference signal or an indication of a virtual resource, wherein the downlink reference signal or the virtual resource is associated with the one or more beam characteristics indicated in the request.

In some implementations, a method of wireless communication performed by an apparatus of a network node includes receiving, from a UE, a request that indicates one or more beam characteristics supported by the UE for a UE-based predictive beam management; and transmitting, to the UE and based at least in part on the request, one or more of a downlink reference signal or an indication of a virtual resource, wherein the downlink reference signal or the virtual resource is associated with the one or more beam characteristics indicated in the request.

In some implementations, a non-transitory computer-readable medium storing a set of instructions for wireless communication includes one or more instructions that, when executed by one or more processors of a UE, cause the UE to: transmit, to a network node, a request that indicates one or more beam characteristics supported by the UE for a UE-based predictive beam management; and receive, from the network node and based at least in part on the request, one or more of a downlink reference signal or an indication of a virtual resource, wherein the downlink reference signal or the virtual resource is associated with the one or more beam characteristics indicated in the request.

In some implementations, a non-transitory computer-readable medium storing a set of instructions for wireless communication includes one or more instructions that, when executed by one or more processors of a network node, cause the network node to: receive, from a UE, a request that indicates one or more beam characteristics supported by the UE for a UE-based predictive beam management; and transmit, to the UE and based at least in part on the request, one or more of a downlink reference signal or an indication of a virtual resource, wherein the downlink reference signal or the virtual resource is associated with the one or more beam characteristics indicated in the request.

In some implementations, an apparatus for wireless communication includes means for transmitting, to a network node, a request that indicates one or more beam characteristics supported by the apparatus for an apparatus-based predictive beam management; and means for receiving, from the network node and based at least in part on the request, one or more of a downlink reference signal or an indication of a virtual resource, wherein the downlink reference signal or the virtual resource is associated with the one or more beam characteristics indicated in the request.

In some implementations, an apparatus for wireless communication includes means for receiving, from a UE, a request that indicates one or more beam characteristics supported by the UE for a UE-based predictive beam management; and means for transmitting, to the UE and based at least in part on the request, one or more of a downlink reference signal or an indication of a virtual resource, wherein the downlink reference signal or the virtual resource is associated with the one or more beam characteristics indicated in the request.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of beam management procedures, in accordance with the present disclosure.

FIG. 5 is a diagram illustrating an example of beam management, in accordance with the present disclosure.

FIGS. 6-12 are diagrams illustrating examples associated with requesting beam characteristics supported by a UE for a predictive management, in accordance with the present disclosure.

FIGS. 13-14 are diagrams illustrating example processes associated with requesting beam characteristics supported by a UE for a predictive management, in accordance with the present disclosure.

FIGS. 15-16 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

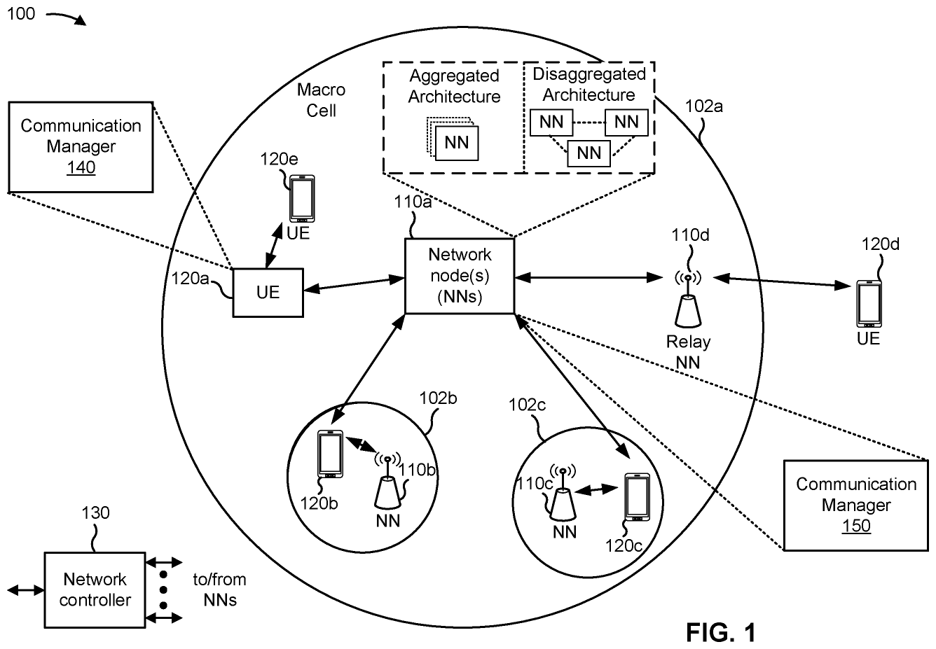

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may transmit, to a network node, a request that indicates one or more beam characteristics supported by the UE for a UE-based predictive beam management; and receive, from the network node and based at least in part on the request, one or more of a downlink reference signal or an indication of a virtual resource, wherein the downlink reference signal or the virtual resource is associated with the one or more beam characteristics indicated in the request. Additionally, or alternatively, the communication manager 140 may perform one or more other operations described herein.

In some aspects, a network node (e.g., network node 110) may include a communication manager 150. As described in more detail elsewhere herein, the communication manager 150 may receive, from a UE, a request that indicates one or more beam characteristics supported by the UE for a UE-based predictive beam management; and transmit, to the UE and based at least in part on the request, one or more of a downlink reference signal or an indication of a virtual resource, wherein the downlink reference signal or the virtual resource is associated with the one or more beam characteristics indicated in the request. Additionally, or alternatively, the communication manager 150 may perform one or more other operations described herein.

As indicated above, FIG. 1 is provided as an example. Other examples may differ from what is described with regard to FIG. 1.

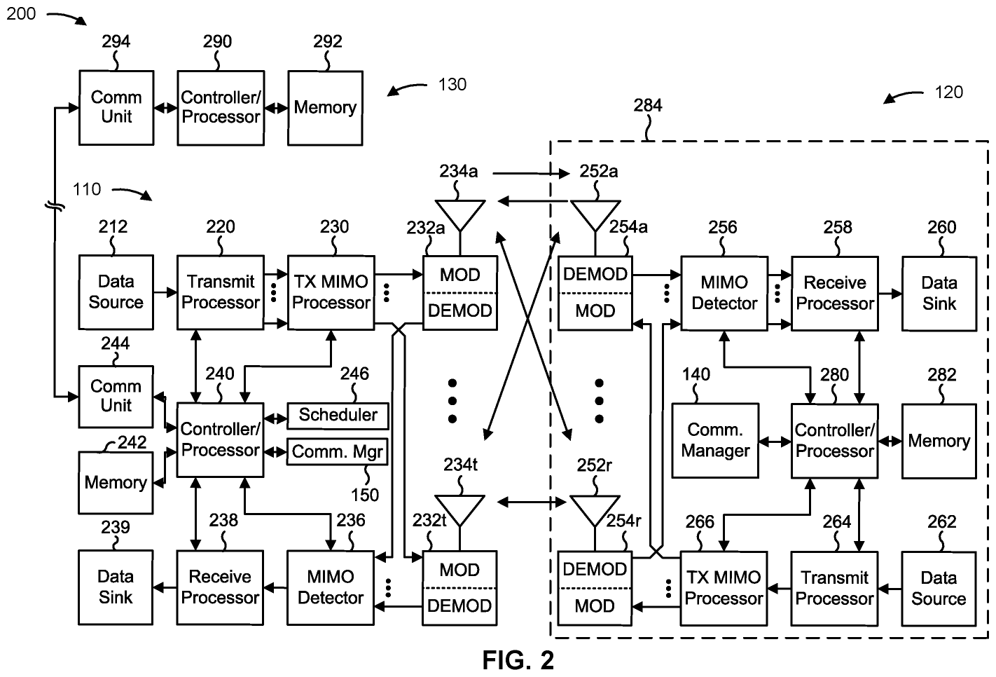

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

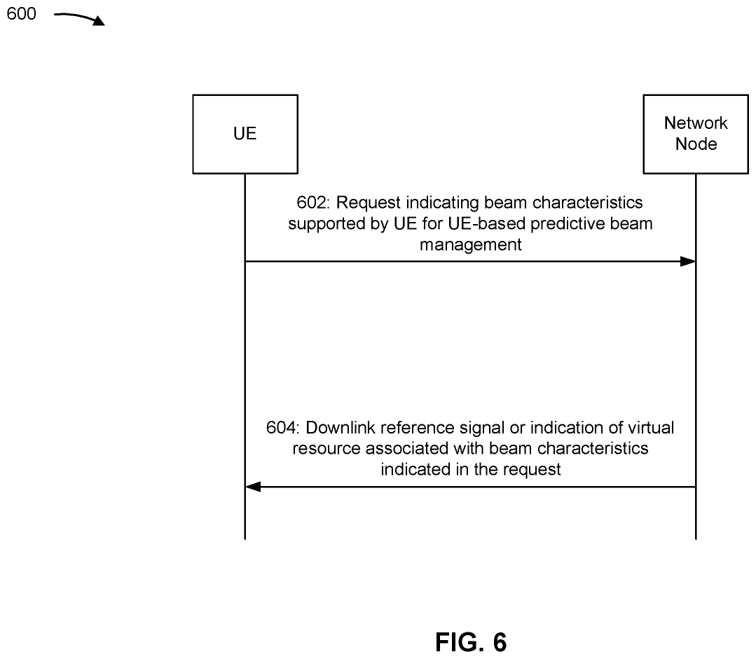

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-16).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-16).

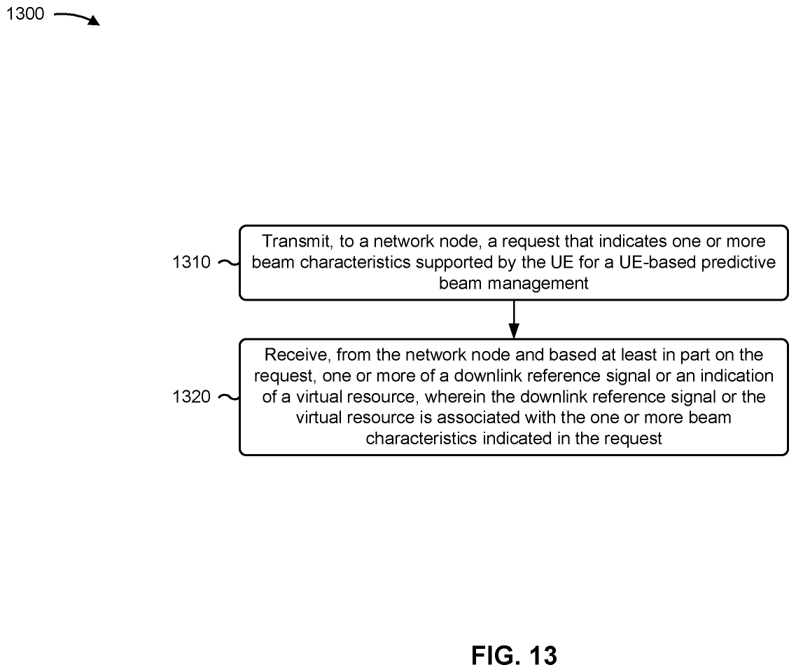

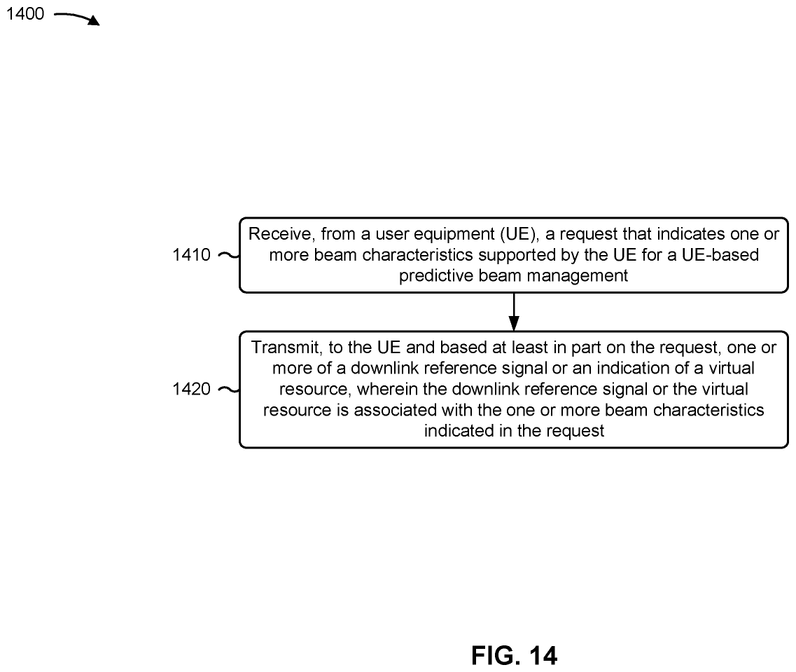

The controller/processor 240 of the network node 110, the controller/processor 280 of the UE 120, and/or any other component(s) of FIG. 2 may perform one or more techniques associated with requesting beam characteristics supported by a UE for a predictive management, as described in more detail elsewhere herein. For example, the controller/processor 240 of the network node 110, the controller/processor 280 of the UE 120, and/or any other component(s) of FIG. 2 may perform or direct operations of, for example, process 1300 of FIG. 13, process 1400 of FIG. 14, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, a UE (e.g., the UE 120) includes means for transmitting, to a network node, a request that indicates one or more beam characteristics supported by the UE for a UE-based predictive beam management; and/or means for receiving, from the network node and based at least in part on the request, one or more of a downlink reference signal or an indication of a virtual resource, wherein the downlink reference signal or the virtual resource is associated with the one or more beam characteristics indicated in the request. In some aspects, the means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for receiving, from a UE, a request that indicates one or more beam characteristics supported by the UE for a UE-based predictive beam management; and/or means for transmitting, to the UE and based at least in part on the request, one or more of a downlink reference signal or an indication of a virtual resource, wherein the downlink reference signal or the virtual resource is associated with the one or more beam characteristics indicated in the request. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

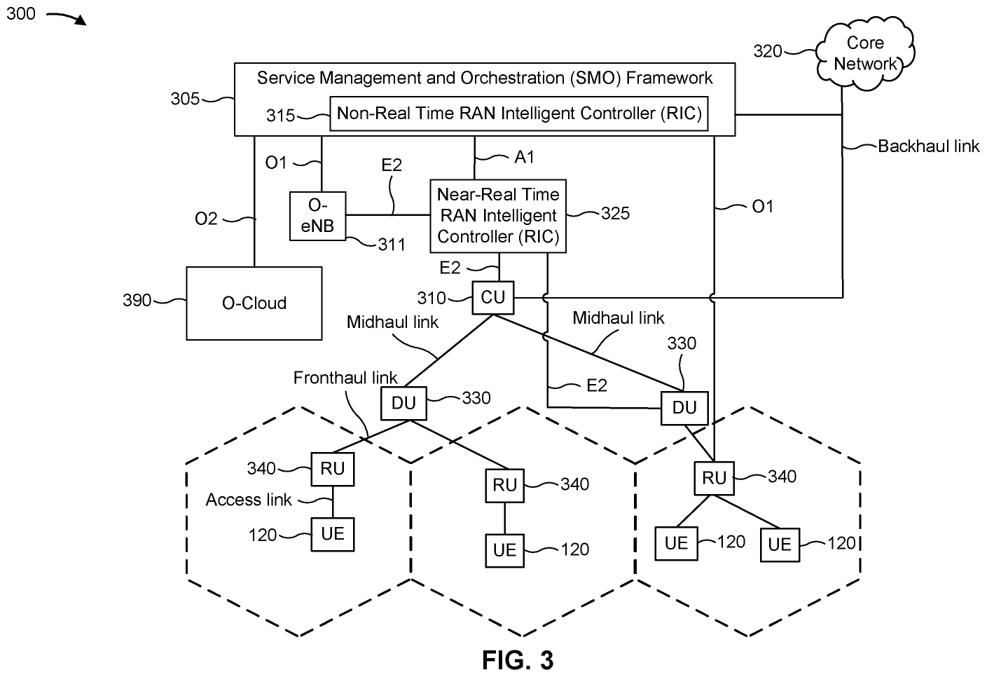

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

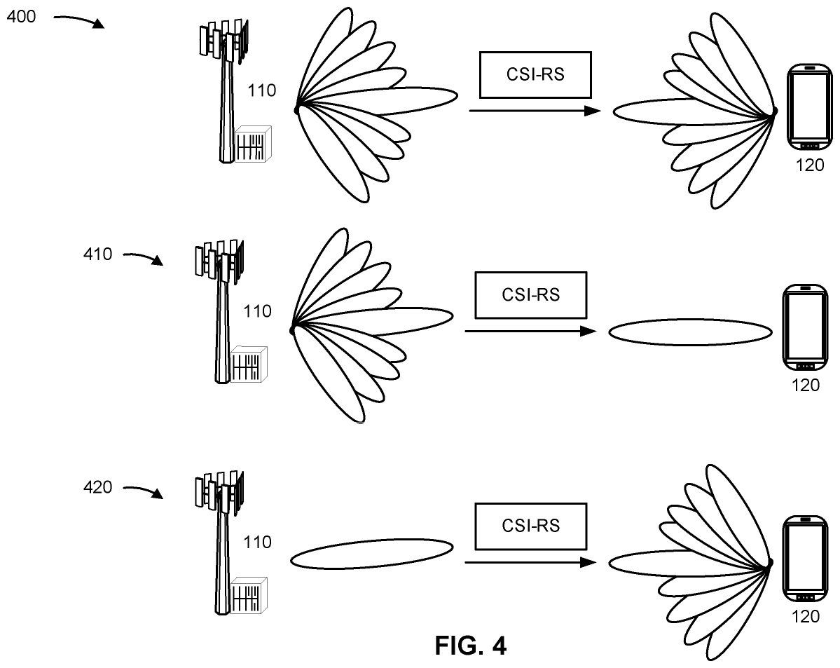

FIG. 4 is a diagram illustrating examples 400, 410, and 420 of beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 and a UE 120 communicating to perform beam management using channel state information reference signals (CSI-RSs). Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using MAC control element (MAC-CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node 110 may use a transmit beam to transmit (e.g., with repetitions) each CSI-RS at multiple times within the same RS resource set so that the UE 120 may sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node 110 may use a transmit beam to transmit (e.g., with repetitions) CSI-RS at multiple times within the same RS resource set so that UE 120 may sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

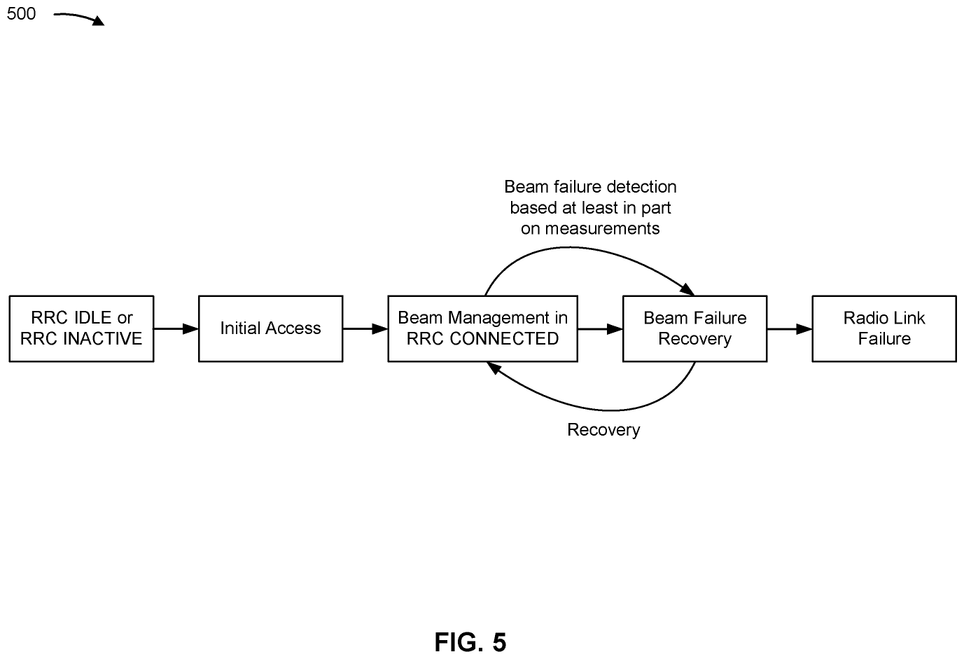

FIG. 5 is a diagram illustrating an example 500 of beam management, in accordance with the present disclosure.

As shown in FIG. 5, a UE may initially be in an RRC idle state or an RRC inactivate state. The UE may perform an initial access and beam management after entering an RRC connected state. The beam management may include P1, P2, and P3 beam management procedures, as described herein. The UE may also perform beam management using an AI/ML-based approach. The UE may perform a beam failure detection (BFD), and the UE may perform a beam failure recovery (BFR) based at least in part on the BFD. When the BFR is not successful, the UE may declare a radio link failure (RLF).

As indicated above, FIG. 5 is provided as an example. Other examples may differ from what is described with regard to FIG. 5.

A network node may include an ML component. The ML component may include one or more ML models for facilitating wireless communication tasks. For example, ML models may be used to facilitate determining parameter values associated with measurements. An ML model may be used to estimate a group of parameters (e.g., interference and/or channel state information (CSI), among other examples) from a common set of inputs (e.g., signal measurements) on current and/or future resources. For example, an ML model may jointly estimate the interference and the CSI on future resources using the same input CSI-RS. In another example, an ML model may estimate the interference on multiple future slots and/or symbols using the same input measurements.

In some cases, to develop a machine learning model of the ML component, a UE may collect data and provide the collected data to the ML component. The ML component may implement a functional framework for developing the ML model. The functional framework may include a data collection function, a model training function, a model inference function, and an actor function. The data collection function may provide training data as input data to the model training function and inference data as input to the model inference function. Examples of input data may include measurements from network nodes, feedback from the actor function, and/or output from an ML model. In some cases, the data collection function may collect and provide data. For example, in some cases, the data collection function may be configured so that ML-algorithm-specific data preparation (e.g., data pre-processing, data cleaning, data formatting, and/or transformation, among other examples) is not performed by the data collection function.

The model training function may perform ML model training, validation, and/or testing, among other examples. The model training function may also perform data preparation (e.g., data pre-processing, data cleaning, data formatting, and/or transformation, among other examples) based on training data delivered by the data collection function. The model training function may deploy an ML model, monitor the ML model, and/or deploy an update of the ML model to the model inference function. The model inference function may provide ML model inference output (e.g., predictions, classifications, estimations, and/or decisions, among other examples). In some cases, the model inference function may provide model performance feedback to the model training function. The model inference function may also perform data preparation (e.g., data pre-processing, data cleaning, data formatting, and/or transformation, among other examples) based on inference data delivered by the data collection function. The actor function may receive the output from the model inference function and perform one or more wireless communication tasks based on the output. The actor function may provide feedback, which may be stored by the data collection function for use as training data and/or inference data.

AI/ML-based predictive beam management may involve beam management using AI/ML. One problem with traditional beam management procedures is that beam qualities/failures are always identified via measurements, which may require more power/overhead to achieve good performance. Further, beam accuracy may be limited due to restrictions on power/overhead, and latency/throughput may be impacted by beam resuming efforts. AI/ML-based predictive beam management may provide predictive beam management in a spatial domain (SD), time domain (TD), and/or frequency domain (FD), which may result in power/overhead reduction and/or accuracy/latency/throughput improvement. AI/ML-based predictive beam management may predict non-measured beam qualities, which may result in lower power/overhead or better accuracy. For example, AI/ML-based predictive beam management may predict future beam blockage/failure, which may result in better latency/throughput. AI/ML-based predictive beam management may be useful because beam prediction is a highly non-linear problem. Predicting future Tx beam qualities may depend on a UE's moving speed/trajectory, Rx beams used or to be used, and/or interference, which may be difficult to model via conventional statistical signaling processing techniques.

AI/ML-based predictive beam management may involve the prediction of beams via AI/ML at the UE or at a network node, which may involve a tradeoff between performance and UE power. In order to predict future DL-Tx beam qualities, the UE may have more observations (via measurements) than the network node (via UE feedbacks). Thus, beam prediction at the UE may outperform beam prediction at the network node, but may involve more UE power consumption. Model training may occur at the network node or at the UE. For model training at the network node, data may be collected via an enhanced air interface or via application-layer approaches. For model training at the UE, additional UE computation/buffering efforts may be needed by model training and data storage.

A network node and/or a UE may perform an AI/ML based SD beam prediction/selection. Layer 1 RSRP (L1-RSRP) measurements may be reported by the UE, or L1-RSRP measurements may be measured by the UE. The L1-RSRP measurements may be associated with SD compressive beam measurements. The L1-RSRP measurements that are reported by the UE may be used to perform an inference at the network node. The L1-RSRP measurements that are measured by the UE may be used to perform an inference at the UE. The AI/ML based SD beam prediction/selection may be based at least in part on the L1-RSRP measurements (measured or reported), where an input of a first set of beams to an AI/ML model may produce an output of a second set of beams. The second set of beams may have more beams as compared to the first set of beams. The output of the second set of beams from the AI/ML model may result in fewer beam measurements, which may result in a UE power reduction. The output of the second set of beams, from the first set of beams, may be associated with a codebook-based SD prediction/selection. The codebook-based SD prediction/selection may be associated with an initial access, a secondary cell group (SCG) setup, a serving beam refinement, and/or a link quality (e.g., channel quality indicator (CQI) or precoding matrix indicator (PMI)) and interference adaptation.

Channel or L1-RSRP measurements may be reported by the UE, or channel or L1-RSRP measurements may be measured by the UE. The channel or L1-RSRP measurements may be facilitated via a raw channel extraction. The channel or L1-RSRP measurements that are reported by the UE may be used to perform an inference at the network node. The channel or L1-RSRP measurements that are measured by the UE may be used to perform an inference at the UE. The AI/ML based SD beam prediction/selection may be based at least in part on the channel or L1-RSRP measurements (measured or reported), where an input of a channel/beams to an AI/ML model may produce an output of a point direction, an angle of departure (AoD), or an angle of arrival (AoA). The output from the AI/ML model may indicate a particular beam (associated with a particular direction), whereas the input may be associated with multiple beams. The output of the point direction, the AoD, or the AoA may result in better beam management accuracy without excessive beam sweepings. The output of the point direction, the AoD, or the AoA, from the input of the channel/beams, may be associated with a non-codebook-based prediction/selection. The non-codebook-based prediction/selection may be associated with a serving beam refinement, and/or a link quality (e.g., CQI or PMI) and interference adaptation.

The network node and/or the UE may perform an AI/ML based SD and TD beam prediction/selection. When SD and TD beam prediction/selection is implemented, a plurality of UE reports or measurements (e.g., channel or L1-RSRP measurements reported by the UE or measured by the UE) over a period of time (e.g., in a time series) may be provided as an input to an AI/ML model. The AI/ML model may produce an output associated with a codebook-based SD and TD beam prediction. The AI/ML model may produce an output associated with a non-codebook-based SD and TD point direction, AoD, and/or AoA prediction. The codebook-based SD and TD beam prediction and the non-codebook-based SD and TD point direction, AoD, and/or AoA prediction may be associated with a joint SD and TD beam prediction. The joint SD and TD beam prediction may be associated with a serving beam refinement, a link quality (e.g., CQI or PMI) and interference adaptation, a beam failure/blockage prediction, and/or an RLF prediction.

For an AI/ML-based beam management, a first case of beam management and a second case of beam management may be supported for characterization and baseline performance evaluations. In the first case, an SD downlink beam prediction for a Set A of beams may be based at least in part on measurement results of a Set B of beams. In the second case, a temporal downlink beam prediction for a Set A of beams may be based at least in part on historic measurement results of a Set B of beams.

For the first case and the second case, a first alternative and a second alternative may be defined. In the first alternative, beams in Set A and beams in Set B may be in the same frequency range. With respect to the first case, the beams in Set B may be a subset of the beams in Set A. A quantity of beams in Set A and a quantity of beams in Set B may be defined. The beams in Set B may be determined from the beams in Set A based at least in part on a fixed pattern or a random pattern. In the second alternative, the beams in Set A may be different than the beams in Set B (e.g., the beams in set B may not be a subset of the beams in Set A). For example, the beams in Set A may be associated with narrow beams, and the beams in Set B may be associated with wide beams. A quantity of beams in Set A and a quantity of beams in Set B may be defined. A quasi-co-location (QCL) relation may be defined between beams in Set A and beams in Set B. With respect to the first alternative and the second alternative, Set A may be associated with a downlink beam prediction and Set B may be associated with a downlink beam measurement. A codebook construction for Set A and a codebook construction for Set B may be defined.

A non-zero-power (NZP) channel state information reference signal (CSI-RS) (NZP-CSI-RS) configuration may be defined. An NZP-CSI-RS may be used as a channel measurement resource (CMR) for a channel state information (CSI)/L1 report, which may be associated with a CSI acquisition or beam management (e.g., L1-RSRP or L1 signal-to-interference-plus-noise ratio (SINR) (L1-SINR) measurement and reporting). The NZP-CSI-RS may be used for tracking (e.g., a tracking reference signal (TRS) may be based at least in part on a single-port CSI-RS). A transmission of the NZP-CSI-RS may be based at least in part on a periodic NZP-CSI-RS, a semi-persistent NZP-CSI-RS, or an aperiodic NZP-CSI-RS. A CSI-RS pattern may be associated with 1, 2, 3, 8, 12, 16, 24, or 32 ports), and a port multiplexing may be based at least in part on a frequency division multiplexing (FDM) or a code division multiplexing (CDM). A QCL relationship acquisition may be per an identified NZP-CSI-RS resource, which may be quasi co-located with a synchronization signal block (SSB) or another CSI-RS. A periodic NZP-CSI-RS may be QCL configured via an RRC configuration of the NZP-CSI-RS. A semi-persistent NZP-CSI-RS may be QCL indicated in the same MAC-CE activation command that activates the semi-persistent NZP-CSI-RS. An aperiodic NZP-CSI-RS may be QCL configured by an aperiodic CSI-RS triggering state configuration, and may be indicated through an uplink grant DCI.

A zero-power CSI-RS (ZP-CSI-RS) may be used for rate matching. A transmission of the ZP-CSI-RS may be based at least in part on a periodic ZP-CSI-RS, a semi-persistent ZP-CSI-RS, or an aperiodic ZP-CSI-RS. CSI-RS patterns that are supported for an NZP-CSI-RS may also be supported for a ZP-CSI-RS.

CSI-RS patterns may be defined and may be associated with different CDM groups. For a given CSI-RS pattern, different CSI-RS components may be placed in a resource block (RB) (e.g., different CSI-RS components may be placed anywhere in the RB). For a given CSI-RS pattern, when different CSI-RS components are not in adjacent OFDM symbols, the different CSI-RS components may be placed in a slot (e.g., the different CSI-RS components may be placed anywhere in the slot). CSI-RS components may be associated with resource elements (REs) in a TD (e.g., OFDM symbols). CSI-RS components may be associated with REs in an FD (e.g., subcarriers).

A maximum quantity of configured or activated CSI-RS resources/ports may be defined. In a slot, a UE may not be expected to have more active CSI-RS ports or active CSI-RS resources in active bandwidth parts (BWPs) than reported as part of a capability signaling. An NZP CSI-RS resource may be active in a duration of time defined. The duration of time may be defined, for an aperiodic CSI-RS, as starting from an end of a physical downlink control channel (PDCCH) containing a request and ending at an end of a scheduled physical uplink shared channel (PUSCH) containing a report associated with the aperiodic CSI-RS. The duration of time may be defined, for a semi-persistent CSI-RS, starting from an end of when an activation command is applied, and ending at an end of when a deactivation command is applied. The duration of time may be defined, for a periodic CSI-RS, starting when the periodic CSI-RS is configured by higher layer signaling, and ending when a periodic CSI-RS configuration is released. When a CSI-RS resource is referred to N times by one or more CSI reporting settings, the CSI-RS resource and CSI-RS ports within the CSI-RS resource may be counted N times.

A CSI-RS interference management (IM) reception for feedback (csi-RS-IM-ReceptionForFeedback) parameter may indicate a UE capability. The csi-RS-IM-ReceptionForFeedback parameter may indicate a support of a CSI-RS and CSI IM reception for CSI feedback. A UE may be required to report the csi-RS-IM-ReceptionForFeedback parameter as part of a capability signaling. The capability signaling may include various parameters. A maximum configured number of NZP-CSI-RSs per component carrier (CC) (maxConfigNumberNZP-CSI-RS-PerCC) parameter may indicate a maximum quantity of configured NZP-CSI-RS resources per CC. A maximum configured number of ports across NZP-CSI-RSs per CC (maxConfigNumberPortsAcrossNZP-CSI-RS-PerCC) parameter may indicate a maximum quantity of ports across a plurality of configured NZP-CSI-RS resources (e.g., all configured NZP-CSI-RS resources) per CC. A maximum configured number of CSI IMs per CC (maxConfigNumberCSI-IM-PerCC) parameter may indicate a maximum quantity of configured CSI IM resources per CC. A maximum number of simultaneous NZP-CSI-RSs per CC (maxNumberSimultaneousNZP-CSI-RS-PerCC) may indicate a maximum quantity of simultaneous CSI-RS resources per CC. A total number of ports for simultaneous NZP-CSI-RSs per CC (totalNumberPorts-SimultaneousNZP-CSI-RS-PerCC) parameter may indicate a total quantity of CSI-RS ports in simultaneous CSI-RS resources per CC.

A beam shape/pointing direction and TD/FD occupation mismatch may occur between a training phase and an inference phase. When an AI/ML model for beam prediction at a UE is trained offline, data that is collected may be filtered based at least in part on a certain beam shape/pointing direction. The data may also be filtered based at least in part on TD/FD occupation assumptions. A generalized AI/ML model may be difficult to train using a large dataset.

When considering a neural network (NN) for TD beam prediction whose inputs are based at least in part on historically measured L1-RSRPs of N SSBs, azimuth beam pointing directions associated with the N wide-beam SSBs may need to be assumed to be along different angles, and associated respective pointing angles may need to be assumed to be available at the UE. When considering an NN for SD beam prediction whose inputs are based at least in part on channel impulse responses (CIRs) or L1-RSRP measurements regarding N wide-beam SSBs, and outputs are based at least in part on L1-RSRP measurements labeled through M>N narrow-beam CSI-RSs, azimuth beam pointing directions associated with the N wide-beam SSBs may need to be assumed to be along different angles, and associated respective pointing angles may need to be assumed to also be available at the UE. The M narrow-beam CSI-RSs may need to be assumed to be pointing at similar angles with refined granularities.

In some cases, the M>N narrow-beam CSI-RSs may still need to be measured by the UE, and M>N narrow-beam CSI-RS measurements may be used as inputs to the AI/ML model. The M>N narrow-beam CSI-RS measurements may be K times less frequent as compared to measurements of the N wide-beam SSBs. A duty cycle ratio K may need to be assumed when training the AI/ML model. When measuring the M narrow-beam CSI-RSs, the total quantity of REs occupied by the M narrow-beam CSI-RSs may be L times higher/lower than the N wide-beam SSBs. An FD density/occupation ratio L may need to be assumed when training the AI/ML model.

When using such AI/ML models for inference during the inference phase, offline-trained models may only be suitable for a beam shape/pointing direction and TD/FD occupation assumed during the training phase. Offline-trained models may not be suitable for beam shapes/pointing directions and TD/FD occupations not assumed during the training phase.

In various aspects of techniques and apparatuses described herein, a UE may transmit, to a network node, a request that indicates one or more beam characteristics supported by the UE for a UE-based predictive beam management. The one or more beam characteristics may include absolute beam shapes, relative beam shapes, associations among a plurality of downlink reference signals transmitted by the network node, FD occupations associated with the plurality of downlink reference signals transmitted by the network node, and/or TD occupations associated with the plurality of downlink reference signals transmitted by the network node. The one or more beam characteristics may include SD beam characteristics, TD beam characteristics, and/or FD beam characteristics. The UE may receive, from the network node and based at least in part on the request, a downlink reference signal and/or an indication of a virtual resource, where the downlink reference signal and/or the virtual resource may be associated with the one or more beam characteristics indicated in the request.

In some aspects, the UE may proactively request and/or report, to the network node, certain beam characteristics (or network node beam characteristics) that the UE supports for its offline/online trained AI/ML models. The network node may attempt to form beams that satisfy a UE requirement based at least in part on the proactive requests and/or reports from the UE. The network node may receive the request, and based at least in part on the request, the network node may transmit the downlink reference signal or indicate the virtual resource, which may be associated with beams that satisfy the UE requirement. By proactively requesting the certain beam characteristics, which may be known to be supported by the offline/online trained AI/ML models of the UE, the UE may implement the UE-based predictive beam management using fewer resources and less power, as compared to if the UE does not proactively request the certain beam characteristics.

FIG. 6 is a diagram illustrating an example 600 associated with requesting beam characteristics supported by a UE for a predictive management, in accordance with the present disclosure. As shown in FIG. 6, example 600 includes communication between a UE (e.g., UE 120) and a network node (e.g., network node 110). In some aspects, the UE and the network node may be included in a wireless network, such as wireless network 100.

As shown by reference number 602, the UE may transmit, to the network node, a request that indicates one or more beam characteristics supported by the UE for a UE-based predictive beam management. The one or more beam characteristics may include absolute beam shapes, relative beam shapes, associations among a plurality of downlink reference signals transmitted by the network node, FD occupations associated with the plurality of downlink reference signals transmitted by the network node, and/or TD occupations associated with the plurality of downlink reference signals transmitted by the network node. The one or more beam characteristics may include SD beam characteristics, TD beam characteristics, and/or FD beam characteristics. In some aspects, the downlink reference signal may be associated with an SSB resource, an NZP-CSI-RS resource, a CMR associated with a CSI report, and/or an interference measurement resource (IMR) associated with a CSI report. In some aspects, the virtual resource may include a CMR associated with a CSI report, and/or an IMR associated with a CSI report.

In some aspects, the UE may proactively request, from the network node, certain beam characteristics (or network node beam characteristics). The UE may proactively request the network node to transmit downlink reference signals to the UE. The UE may proactively request the network node to indicate, to the UE, virtual resources (or nominal resources). The virtual resources may be used for beam prediction/selection by the UE, but may not actually be transmitted by the network node. The UE may be indicated with identifiers associated with the virtual resources. The UE may transmit, to the network node, feedback regarding the virtual resources.

The UE may proactively request the downlink reference signals and/or virtual resources to have certain on-demand beam characteristics (or network node beam characteristics). The beam characteristics, which may be associated with the network node, may include absolute or relative beam shapes, associations or connections or correspondences among the transmitted downlink reference signals, and/or TD/FD occupations of the transmitted downlink reference signals. The beam characteristics may be supported by the UE for the UE's offline-trained AI/ML models. In other words, the UE may request certain on-demand beam characteristics that are known to be supported by the UE for the UE's offline-trained AI/ML models.

In some aspects, requested downlink reference signals may be associated with SSB resources, NZP-CSI-RS resources, CMRs associated with a CSI report, or IMRs associated with the CSI report. In some aspects, requested virtual resources may not actually be transmitted. The requested virtual resources may be associated with CMRs (or virtual CMRs) associated with the CSI report. The requested virtual resources may be associated with IMRs (or virtual IMRs) associated with the CSI report.

In some aspects, the UE may transmit a request for a first set of downlink reference signal resources to have beam pointing directions associated with a first quantity of pointing directions and beam widths associated with a first quantity of beam widths. The UE may transmit a request for a second set of downlink reference signal resources to have beam pointing directions associated with a second quantity of pointing directions and beam widths associated with a second quantity of beam widths. The UE may transmit a request for a third set of virtual resources to have beam pointing directions associated with a third quantity of pointing directions and beam widths associated with a third quantity of beam widths.

In some aspects, the UE may transmit, to the network node, requests for SD beam characteristics. The UE may proactively request, from the network node, the SD beam characteristics regarding SSBs or NZP-CSI-RSs transmitted by the network node, or regarding virtual resources that are not actually transmitted by the network node. The UE may request, from the network node, a first set of SSB/NZP-CSI-RS resources, whose beam pointing directions may be associated with the first quantity of pointing directions, and whose beam widths may be associated with the first quantity of beam widths. For example, the UE may request to be transmitted with 16 CSI-RS resources, whose elevation pointing directions are all −10 degrees (in terms of a global coordinate system (GCS)), whose azimuth pointing directions are 8 degrees for adjacent SSB resources, and whose 3 dB beam widths are all 9 degrees. The UE may further request, from the network node, a second set of SSB/NZP-CSI-RS resources, whose beam pointing directions may be associated with the second quantity of pointing directions, and whose beam widths may be associated with the second quantity of beam widths. For example, the UE may request to be further transmitted with 64 NZP-CSI-RS resources, whose elevation pointing directions are all −10 degrees (in terms of a GCS), whose azimuth pointing directions are 2 degrees for adjacent NZP-CSI-RS resources, and whose 3 dB beam widths are all 3 degrees. The UE may further request, from the network node, the third set of virtual resources that are not actually transmitted, whose virtual beam pointing directions may be associated with the third quantity of pointing directions, and whose beam widths may be associated with a third quantity of beam widths. For example, the UE may request to be further indicated with 64 virtual resources, whose elevation pointing directions are all −10 degrees (in terms of a GCS), whose azimuth pointing directions are 2 degrees for adjacent NZP-CSI-RS resources, and whose 3 dB beam widths are all 3 degrees.

In some aspects, the UE may transmit a request for an SD connection between different sets of resources. The different sets of resources may include the first set of downlink reference signal resources, the second set of downlink reference signal resources, and/or the third set of virtual resources. The SD connection may be a pointing direction connection or a beam width connection.

In some aspects, the UE may request SD connections between the different sets of resources. The UE may request the first set of SSB/NZP-CSI-RS resources, the second set of SSB/NZP-CSI-RS resources, and the third set of virtual resources. The UE may further request the second set of SSB/NZP-CSI-RS resources or the third set of virtual resources to be connected in an SD with the first set of SSB/NZP-CSI-RS resources. In some aspects, the SD connection may be the pointing direction connection. The UE may further request beam pointing direction relationships between a certain resource in the first set of SSB/NZP-CSI-RS resources and another resource in the second set of SSB/NZP-CSI-RS resources or the third set of virtual resources. For example, the UE may request that at least one resource is present in the second set of SSB/NZP-CSI-RS resources or the third set of virtual resources whose azimuth beam pointing direction is 3 degrees different from a certain resource in the first set of SSB/NZP-CSI-RS resources, and the resources should share identical elevation pointing directions. In some aspects, the SD connection may be the beam width connection. The UE may further request beam width relationships between a certain resource in the first set of SSB/NZP-CSI-RS resources and another resource in the second set of SSB/NZP-CSI-RS resources or the third set of virtual resources. For example, the UE may request that the resource in the second set of SSB/NZP-CSI-RS resources or the third set of virtual resources is associated with a 3 dB beam width being 30% of the resource in the first set of SSB/NZP-CSI-RS resources.

In some aspects, the request may be associated with an actual CMR associated with a CSI report. The request may be associated with an actual IMR associated with a CSI report. The request may be associated with a virtual CMR associated with a CSI report. The request may be associated with a virtual IMR associated with a CSI report. In other words, the UE may request the SD connections between different sets of resources, and such requests may regard actual/virtual CMRs/IMRs associated with a certain CSI report.

As an example, in a training phase, the UE may use a first set of SSB/NZP-CSI-RS resources as Set B beams and a second set of SSB/NZP-CSI-RS resources as Set A beams for offline/online model training. As another example, in an inference phase, the UE may use the first set of SSB/NZP-CSI-RS resources as Set B beams and the second set of SSB/NZP-CSI-RS resources or the third set of virtual resources as Set A beams for model inference. An AI/ML model may be trained assuming that the Set A beams and the Set B beams are connected in terms of SD characteristics.

In some aspects, the UE may transmit a request for a first set of downlink reference signal resources to have a periodicity equal to a first quantity of slots or a first quantity of time. The UE may transmit a request for a second set of downlink reference signal resources to have a periodicity equal to a second quantity of slots or a second quantity of time. The UE may transmit a request for a third set of virtual resources.

In some aspects, the UE may transmit, to the network node, requests for TD beam characteristics. The UE may proactively request, from the network node, the TD beam characteristics regarding SSBs/NZP-CSI-RSs transmitted by the network node, or TD beam characteristics regarding virtual resources that are not actually transmitted by the network node. In other words, the UE may proactively request the TD beam characteristics regarding network-node-transmitted SSBs/NZP-CSI-RSs or virtual resources that are not actually transmitted. The UE may request, from the network node, a first set of SSB or periodic/semi-persistent NZP-CSI-RS resources, whose periodicity may be equal to a first quantity of slots/ms. For example, the UE may request a first set of 16 CSI-RS resources, and the UE may further request that the first set of 16 CSI-RS resources be associated with a periodicity of 5 ms. The UE may request, from the network node, a second set of SSB or periodic/semi-persistent NZP-CSI-RS resources, whose periodicity may be equal to a second quantity of slots/ms. For example, the UE may request a second set of 64 CSI-RS resources, and the UE may further request that the second set of 64 CSI-RS resources be associated with a periodicity of 500 ms. The UE may request, from the network node, the third set of virtual resources that are not actually transmitted by the network node.

In some aspects, the UE may transmit a request for a TD connection between different sets of resources. The different sets of resources may include the first set of downlink reference signal resources, the second set of downlink reference signal resources, and/or the third set of virtual resources, where the TD connection may be associated with a periodicity.

In some aspects, the UE may request TD connections between the different sets of resources. The UE may request the first set of SSB/NZP-CSI-RS resources, the second set of SSB/NZP-CSI-RS resources, and the third set of virtual resources. The UE may further request the second set of SSB/NZP-CSI-RS resources or the third set of virtual resources to be connected in a TD with the first set of SSB/NZP-CSI-RS resources. The UE may further request periodicity relationships between a certain resource in the first set of SSB/NZP-CSI-RS resources and another resource in the second set of SSB/NZP-CSI-RS resources. For example, the UE may request that at least one resource is present in the second set of SSB/NZP-CSI-RS resources (with certain SD characteristics) whose TD characteristics are associated with a periodicity that is ten times a periodicity of a certain resource in the first set of SSB/NZP-CSI-RS resources. The UE may request that a virtual resource in the third set of virtual resources be a virtual resource that is not actually transmitted by the network node. In some aspects, the UE may request the TD connections between different sets of resources, and such requests may regard actual/virtual CMRs/IMRs associated with a certain CSI report.

As an example, a network node may still transmit Set A beams during an inference phase. A UE may use a first set of SSB/NZP-CSI-RS resources as Set B beams and a second set of SSB/NZP-CSI-RS as Set A beams for model inference. An AI/ML model may be trained assuming that the Set A beams are transmitted with a periodicity that is less than or equal to 500 ms. The AI/ML model may be trained assuming certain SD characteristics. As another example, a network node may not transmit Set A beams during an inference phase. A UE may use a first set of SSB/NZP-CSI-RS resources as Set B beams and a third set of virtual resources as Set A beams for model inference. An AI/ML model may be trained assuming that the Set A beams are not transmitted. The AI/ML model may be trained assuming certain SD characteristics.

In some aspects, the UE may transmit a request for a first set of downlink reference signal resources to have an FD density equal to a first quantity of a physical resource block (PRB) density, a first quantity of REs per PRB, and/or a total quantity of occupied PRBs equal to a first quantity of PRBs. The UE may transmit a request for a second set of downlink reference signal resources to have an FD density equal to a second quantity of a PRBs density, a second quantity of REs per PRB, and/or a total quantity of occupied PRBs equal to a second quantity of PRBs.

In some aspects, the UE may transmit, to the network node, requests of FD beam characteristics. The UE may proactively request, from the network node, the FD beam characteristics regarding SSBs/NZP-CSI-RSs transmitted by the network node. In other words, the UE may proactively request the FD beam characteristics regarding network-node-transmitted SSBs/NZP-CSI-RSs. The UE may request, from the network node, a first set of SSB or periodic/semi-persistent NZP-CSI-RS resources, whose FD density may be equal to the first quantity of the PRB density and/or the quantity of RES per PRB, and/or whose total quantity of occupied PRBs may be equal to the first quantity of PRBs. For example, the UE may request a first set of 16 CSI-RS resources, and the UE may further request that the first set of 16 CSI-RS resources be associated with an FD density equal to every one PRB with three REs per PRB, and that the first set of 16 CSI-RS resources occupy altogether 16 PRBs. The UE may request, from the network node, a second set of SSB or periodic/semi-persistent NZP-CSI-RS resources, whose FD density may be equal to the second quantity of the PRB density and/or the quantity of REs per PRB, and/or whose total number of occupied PRBs may be equal to the second quantity of PRBs. For example, the UE may request a second set of 64 CSI-RS resources, and the UE may further request that the second set of 64 CSI-RS resources be associated with an FD density equal to every three PRBs with one RE per PRB, and that the second set of 64 CSI-RS resources occupy altogether 8 PRBs.

In some aspects, the UE may transmit a request for an FD connection between different sets of resources. The different sets of resources may include the first set of downlink reference signal resources and the second set of downlink reference signal resources. The FD connection may be associated with an FD density in terms of a PRB density or a quantity of REs per PRB.

In some aspects, the UE may request FD connections between the different sets of resources. The UE may request the first set of SSB/NZP-CSI-RS resources and the second set of SSB/NZP-CSI-RS resources. The UE may further request the second set of SSB/NZP-CSI-RS resources to be connected in an FD with the first set of SSB/NZP-CSI-RS resources. The UE may further request FD density/occupation relationships between a certain resource in the first set of SSB/NZP-CSI-RS resources and another resource in the second set of SSB/NZP-CSI-RS resources. For example, the UE may request that at least one resource is present in the second set of SSB/NZP-CSI-RS resources (with certain SD characteristics and certain TD characteristics) whose FD characteristics are associated with an FD density that is three limes lower than a certain resource in the first set of SSB/NZP-CSI-RS resources, and in terms of both a PRB density and a quantity of REs per PRB. In some aspects, the UE may request the FD connections between different sets of resources, and such requests may regard actual/virtual CMRs/IMRs associated with a certain CSI report.

As an example, during a training phase, a UE may use a first set of SSB/NZP-CSI-RS resources as Set B beams and a second set of SSB/NZP-CSI-RS as Set A beams (with certain SD and TD characteristics) for offline/online model training. As another example, a UE may use a first set of SSB/NZP-CSI-RS resources as Set B beams and a second set of SSB/NZP-CSI-RS resources as Set A beams for model inference. An AI/ML model may be trained assuming that the Set A beams and the Set B beams are connected in terms of FD characteristics.

In some aspects, the UE-based predictive beam management may be associated with an offline or online model training during a training phase using one or more of the downlink reference signal or the virtual resource. The UE-based predictive beam management may be associated with a model inference during an inference phase using one or more of the downlink reference signal or the virtual resource.

In some aspects, the UE may request CSI reports/resources for a UE-based predictive beam management. For a UE-based training or offline training, the UE may request a CSI report with a report quantity that is set to none. The UE may request CMRs/IMRs associated with the CSI report, where the request may be associated with SD beam characteristics, TD beam characteristics, and/or FD beam characteristics. Alternatively, the UE may directly request CSI-RS resources, where the request may be associated with SD beam characteristics, TD beam characteristics, and/or FD beam characteristics. For a UE-based model inference, the UE may request a CSI report with a report quantity that includes an L1-RSRP, an L1-SINR, a rank indicator (RI), a CQI, a PMI, a layer indicator (LI), a CSI-RS resource indicator (CRI), and/or an SSB resource indicator (SSBRI), or a virtual resource indicator. The UE may request CMRs/IMRs associated with the CSI report, where the request may be associated with SD beam characteristics, TD beam characteristics, and/or FD beam characteristics.

In some aspects, the UE may transmit the request based at least in part on a UE capability report that indicates types of SD, TD, and FD beam characteristics supported by the UE, and an on-demand UE request for on-demand beam characteristics.

In some aspects, the UE may transmit requests to the network node. The requests may be based at least in part on a UE capability report. A UE capability reporting may indicate types of SD, TD, and/or FD beam characteristics that the UE is able to support. The requests may be based at least in part on on-demand UE requests. The UE may transmit such requests via RRC signaling, a MAC-CE, or uplink control information (UCI), which may enable the UE to request such CSI reports on-demand. The on-demand UE requests may be based at least in part on the network node indicating, per CC, SD beam characteristics supported by the network node. The UE may indicate, to the network node, preferred options together with TD and/or FD characteristics associated with beams. The UE may use a MAC-CE or UCI to dynamically change requested beam characteristics associated with an already active CSI report.

As shown by reference number 604, the UE may receive, from the network node and based at least in part on the request, the downlink reference signal and/or an indication of the virtual resource. The downlink reference signal and/or the virtual resource may be associated with the one or more beam characteristics indicated in the request. The network node may form the downlink reference signal and/or the virtual resource to have beams that correspond to the one or more beam characteristics indicated in the request. In other words, the network node may attempt to transmit downlink reference signals using beams that satisfy a UE requirement, where the UE requirement may correspond to beam characteristics supported by the UE for an offline/online trained AI/ML model of the UE. The network node may attempt to indicate virtual resources that are associated with beams that satisfy the UE requirement. As a result, the UE may use the downlink reference signal and/or the virtual reference when performing a UE-based predictive beam management. By using downlink reference signals and/or virtual references that are associated with the beam characteristics supported by the UE, the UE may perform the UE-based predictive beam management using less power and greater accuracy, as compared to if the UE performed the UE-based predictive beam management using reference signals and/or virtual resources that were not all supported by the UE.

As indicated above, FIG. 6 is provided as an example. Other examples may differ from what is described with regard to FIG. 6.

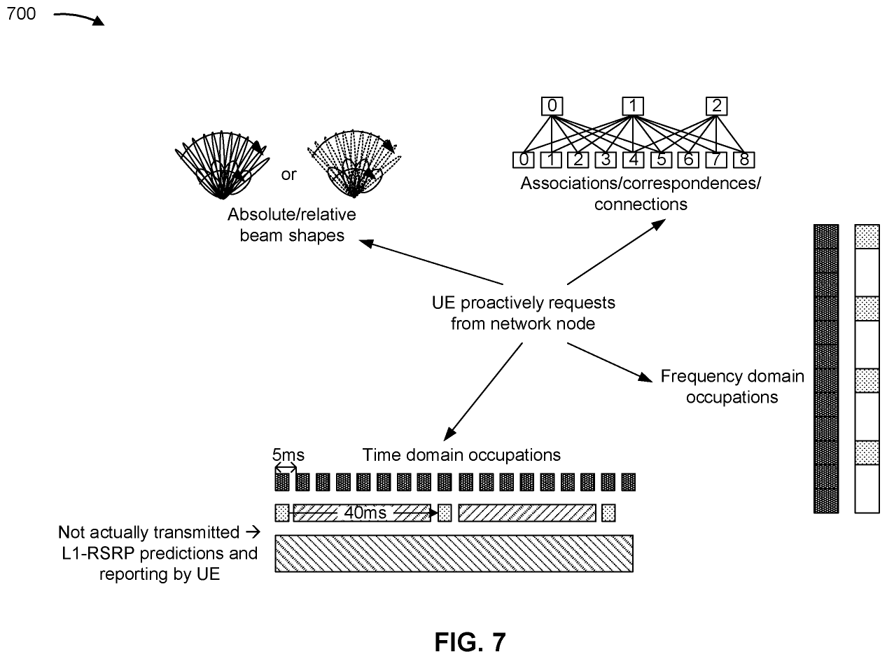

FIG. 7 is a diagram illustrating an example 700 associated with requesting beam characteristics supported by a UE for a predictive management, in accordance with the present disclosure.

As shown in FIG. 7, a UE may proactively request, from a network node, certain network node beam characteristics. The network node beam characteristics may include absolute or relative beam shapes. The network node beam characteristics may include associations, connections, and/or correspondence between transmitted downlink reference signals and/or virtual resources. The network node beam characteristics may include FD occupations of transmitted downlink reference signals and/or virtual resources. The network node beam characteristics may include TD occupations of transmitted downlink reference signals and/or virtual resources. The virtual resources may not actually be transmitted by the network node, and the virtual resources may be used by the UE to perform L1-RSRP predictions and reporting.

As indicated above, FIG. 7 is provided as an example. Other examples may differ from what is described with regard to FIG. 7.

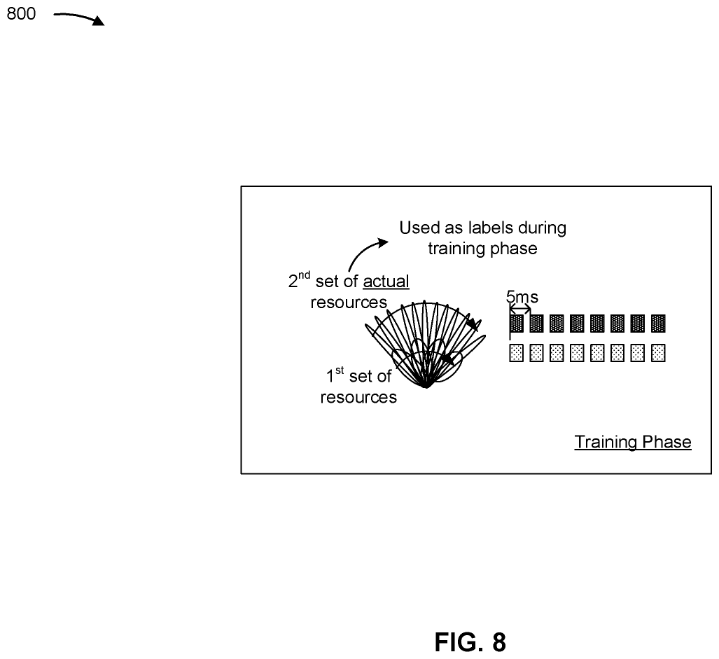

FIG. 8 is a diagram illustrating an example 800 associated with requesting beam characteristics supported by a UE for a predictive management, in accordance with the present disclosure.

As shown in FIG. 8, in a training phase, a UE may request a first set of SSB/NZP-CSI-RS resources and a second set of SSB/NZP-CSI-RS resources. The UE may use the first set of SSB/NZP-CSI-RS resources as Set B beams for offline/online model training. The Set B beams may be associated with wide beams. The UE may use the second set of SSB/NZP-CSI-RS resources as Set A beams for the offline/online model training. The second set of SSB/NZP-CSI-RS resources may be associated with actual resources, and may be used as labels during the training phase. The Set A beams may be associated with narrow beams.

As indicated above, FIG. 8 is provided as an example. Other examples may differ from what is described with regard to FIG. 8.

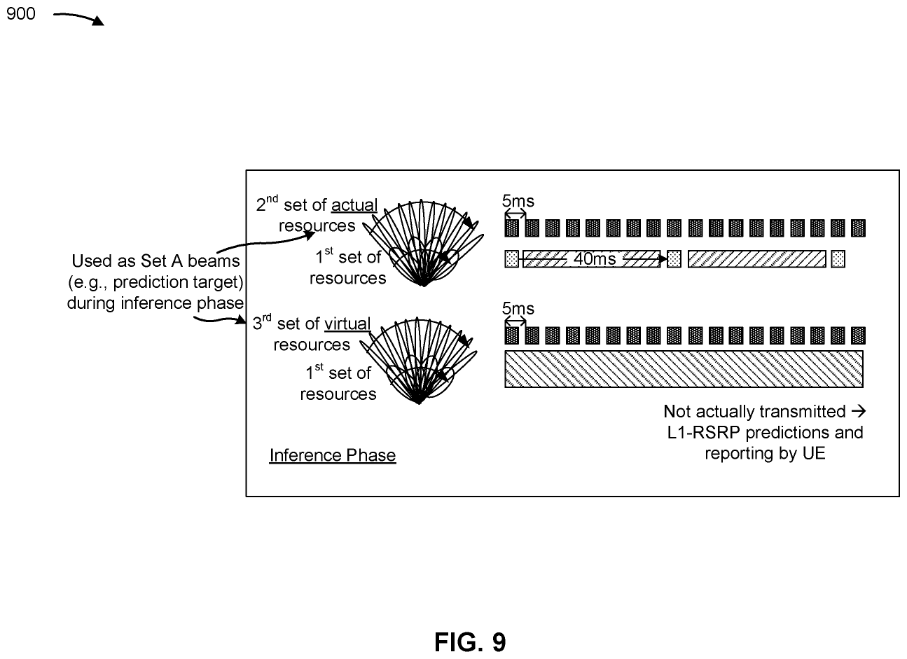

FIG. 9 is a diagram illustrating an example 900 associated with requesting beam characteristics supported by a UE for a predictive management, in accordance with the present disclosure.

As shown in FIG. 9, in an inference phase, a UE may request a first set of SSB/NZP-CSI-RS resources, a second set of SSB/NZP-CSI-RS resources, and a third set of virtual resources. The UE may use the first set of SSB/NZP-CSI-RS resources as Set B beams for model inference. The Set B beams may be associated with wide beams. The UE may use the second set of SSB/NZP-CSI-RS resources or the third set of virtual resources as Set A beams for the model inference (e.g., Set A beams associated with a prediction target during the interference phase). The second set of SSB/NZP-CSI-RS resources may be associated with actual resources. The Set A beams may be associated with narrow beams. The third set of virtual resources may correspond to virtual resources that are not actually transmitted, and which may be used for L1-RSRP predictions and reporting by the UE.

As indicated above, FIG. 9 is provided as an example. Other examples may differ from what is described with regard to FIG. 9.

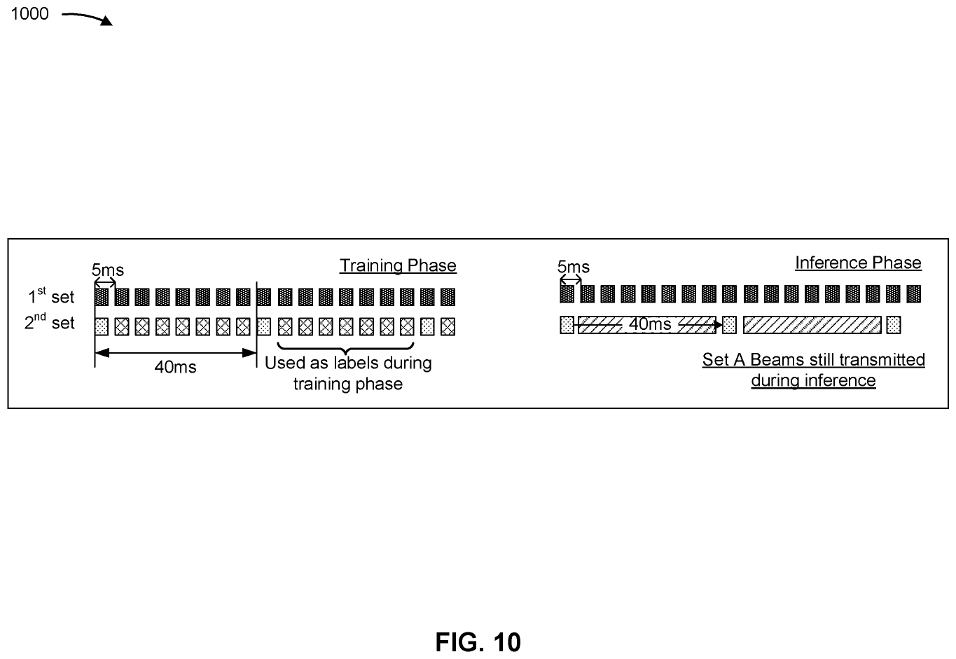

FIG. 10 is a diagram illustrating an example 1000 associated with requesting beam characteristics supported by a UE for a predictive management, in accordance with the present disclosure.

As shown in FIG. 10, during a training phase, a UE may use a first set of SSB/NZP-CSI-RS resources as Set B beams for offline/online model training. The UE may use a second set of SSB/NZP-CSI-RS resources as Set A beams for offline/online model training. The first and second sets of SSB/NZP-CSI-RS resources may be associated with TD occupations. Some of the second set of SSB/NZP-CSI-RS resources may be used as labels during the training phase. During an inference phase, the UE may use the first set of SSB/NZP-CSI-RS resources as Set B beams. Further, during the inference phase, the UE may use the second set of SSB/NZP-CSI-RS resources as the Set A beams. In other words, the Set A beams may still be transmitted during the inference phase. During the inference phase, the Set A beams may be transmitted with a periodicity of 40 ms.

As indicated above, FIG. 10 is provided as an example. Other examples may differ from what is described with regard to FIG. 10.

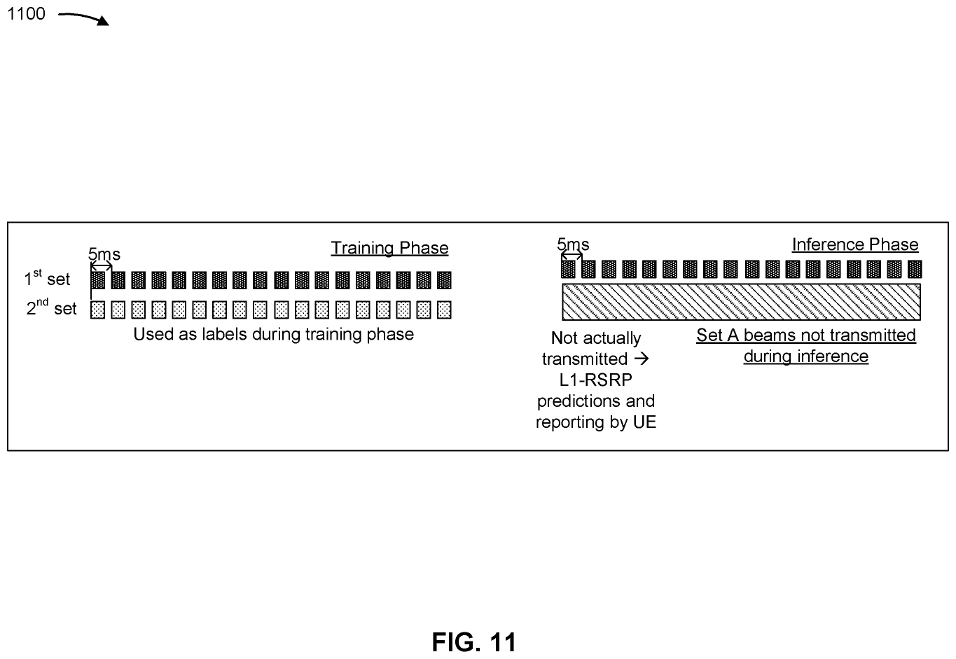

FIG. 11 is a diagram illustrating an example 1100 associated with requesting beam characteristics supported by a UE for a predictive management, in accordance with the present disclosure.

As shown in FIG. 11, during a training phase, a UE may use a first set of SSB/NZP-CSI-RS resources as Set B beams for offline/online model training. The UE may use a second set of SSB/NZP-CSI-RS resources as Set A beams for offline/online model training. The first and second sets of SSB/NZP-CSI-RS resources may be associated with TD occupations. The second set of SSB/NZP-CSI-RS resources may be used as labels during the training phase. During an inference phase, the UE may use the first set of SSB/NZP-CSI-RS resources as Set B beams. Further, during the inference phase, the UE may use a third set of virtual resources as the Set A beams. In other words, the Set A beams may not be transmitted during the inference period.

As indicated above, FIG. 11 is provided as an example. Other examples may differ from what is described with regard to FIG. 11.

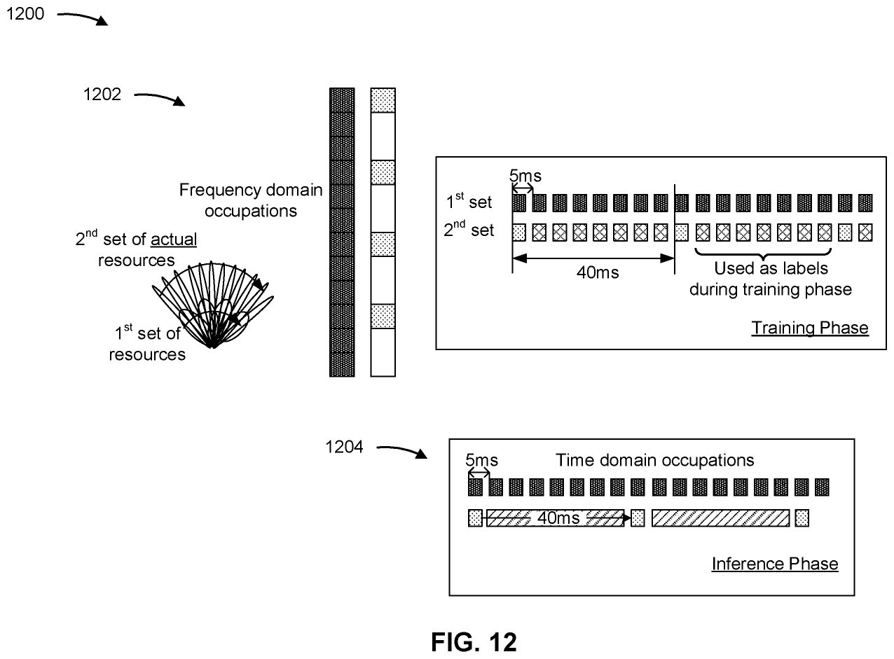

FIG. 12 is a diagram illustrating an example 1200 associated with requesting beam characteristics supported by a UE for a predictive management, in accordance with the present disclosure.

As shown by reference number 1202, during a training phase, a UE may use a first set of SSB/NZP-CSI-RS resources as Set B beams for offline/online model training. The UE may use a second set of SSB/NZP-CSI-RS resources as Set A beams for offline/online model training. The first and second sets of SSB/NZP-CSI-RS resources may be associated with FD occupations. Some of the second set of SSB/NZP-CSI-RS resources may be used as labels during the training phase. As shown by reference number 1204, during an inference phase, the UE may use the first set of SSB/NZP-CSI-RS resources as Set B beams. Further, during the inference phase, the UE may use the second set of SSB/NZP-CSI-RS resources as the Set A beams. The UE may use the first and second sets of SSB/NZP-CSI-RS resources for model inference, where an AI/ML model may be trained assuming that the Set A beams and the Set B beams are connected in terms of FD characteristics. The Set A beams may still be transmitted during the inference phase. During the inference phase, the Set A beams may be transmitted with a periodicity of 40 ms.

As indicated above, FIG. 12 is provided as an example. Other examples may differ from what is described with regard to FIG. 12.

FIG. 13 is a diagram illustrating an example process 1300 performed, for example, by a UE, in accordance with the present disclosure. Example process 1300 is an example where the UE (e.g., UE 120) performs operations associated with requesting beam characteristics supported by a UE for a predictive beam management.

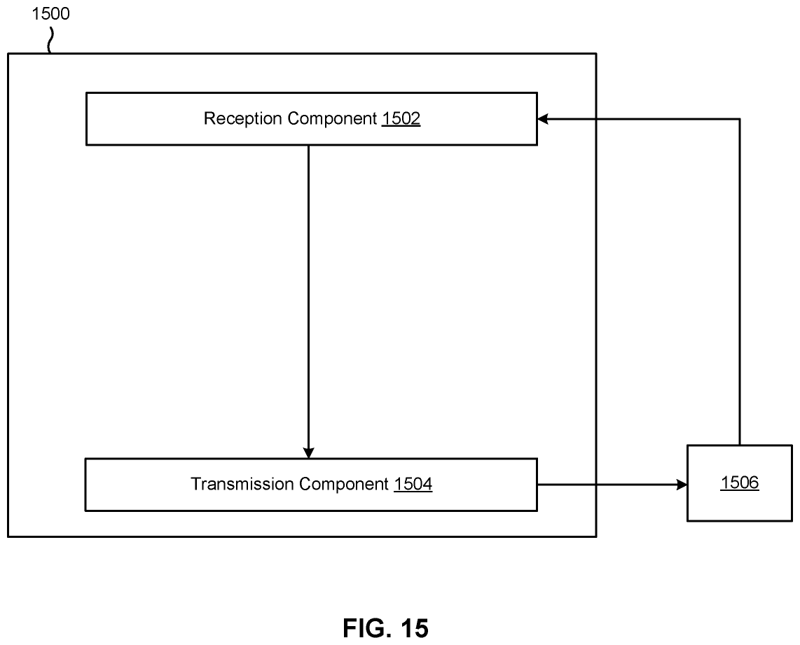

As shown in FIG. 13, in some aspects, process 1300 may include transmitting, to a network node, a request that indicates one or more beam characteristics supported by the UE for a UE-based predictive beam management (block 1310). For example, the UE (e.g., using transmission component 1504, depicted in FIG. 15) may transmit, to a network node, a request that indicates one or more beam characteristics supported by the UE for a UE-based predictive beam management, as described above.

As further shown in FIG. 13, in some aspects, process 1300 may include receiving, from the network node and based at least in part on the request, one or more of a downlink reference signal or an indication of a virtual resource, wherein the downlink reference signal or the virtual resource is associated with the one or more beam characteristics indicated in the request (block 1320). For example, the UE (e.g., using reception component 1502, depicted in FIG. 15) may receive, from the network node and based at least in part on the request, one or more of a downlink reference signal or an indication of a virtual resource, wherein the downlink reference signal or the virtual resource is associated with the one or more beam characteristics indicated in the request, as described above.

Process 1300 may include additional aspects, such as any single aspect or any combination of aspects described below and/or in connection with one or more other processes described elsewhere herein.

In a first aspect, the one or more beam characteristics include one or more of absolute beam shapes, relative beam shapes, associations among a plurality of downlink reference signals transmitted by the network node, FD occupations associated with the plurality of downlink reference signals transmitted by the network node, or TD occupations associated with the plurality of downlink reference signals transmitted by the network node.

In a second aspect, alone or in combination with the first aspect, the one or more beam characteristics include one or more of SD beam characteristics, TD beam characteristics, or FD beam characteristics.

In a third aspect, alone or in combination with one or more of the first and second aspects, the downlink reference signal is associated with an SSB resource, an NZP-CSI-RS resource, a CMR associated with a CSI report, or an IMR associated with a CSI report.

In a fourth aspect, alone or in combination with one or more of the first through third aspects, the virtual resource includes a CMR associated with a CSI report, or an IMR associated with a CSI report.

In a fifth aspect, alone or in combination with one or more of the first through fourth aspects, process 1300 includes transmitting a request for a first set of downlink reference signal resources to have beam pointing directions associated with a first quantity of pointing directions and beam widths associated with a first quantity of beam widths, transmitting a request for a second set of downlink reference signal resources to have beam pointing directions associated with a second quantity of pointing directions and beam widths associated with a second quantity of beam widths, and transmitting a request for a third set of virtual resources to have beam pointing directions associated with a third quantity of pointing directions and beam widths associated with a third quantity of beam widths.

In a sixth aspect, alone or in combination with one or more of the first through fifth aspects, process 1300 includes transmitting a request for an SD connection between different sets of resources, wherein the different sets of resources include one or more of a first set of downlink reference signal resources, a second set of downlink reference signal resources, or a third set of virtual resources, and the SD connection is one of a pointing direction connection or a beam width connection.

In a seventh aspect, alone or in combination with one or more of the first through sixth aspects, the request is associated with an actual CMR associated with a CSI report, the request is associated with an actual IMR associated with a CSI report, the request is associated with a virtual CMR associated with a CSI report, or the request is associated with a virtual IMR associated with a CSI report.

In an eighth aspect, alone or in combination with one or more of the first through seventh aspects, process 1300 includes transmitting a request for a first set of downlink reference signal resources to have a periodicity equal to a first quantity of slots or a first quantity of time, transmitting a request for a second set of downlink reference signal resources to have a periodicity equal to a second quantity of slots or a second quantity of time, and transmitting a request for a third set of virtual resources.

In a ninth aspect, alone or in combination with one or more of the first through eighth aspects, process 1300 includes transmitting a request for a TD connection between different sets of resources, wherein the different sets of resources include one or more of a first set of downlink reference signal resources, a second set of downlink reference signal resources, or a third set of virtual resources, and the TD connection is associated with a periodicity.

In a tenth aspect, alone or in combination with one or more of the first through ninth aspects, process 1300 includes transmitting a request for a first set of downlink reference signal resources to have one or more of an FD density equal to a first quantity of PRBs density, a first quantity of REs per PRB, or a total quantity of occupied PRBs equal to a first quantity of PRBs, and transmitting a request for a second set of downlink reference signal resources to have one or more of an FD density equal to a second quantity of PRBs density, a second quantity of REs per PRB, or a total quantity of occupied PRBs equal to a second quantity of PRBs.

In an eleventh aspect, alone or in combination with one or more of the first through tenth aspects, process 1300 includes transmitting a request for an FD connection between different sets of resources, wherein the different sets of resources include a first set of downlink reference signal resources and a second set of downlink reference signal resources, and the FD connection is associated with an FD density in terms of a PRB density or a quantity of REs per PRB.

In a twelfth aspect, alone or in combination with one or more of the first through eleventh aspects, the UE-based predictive beam management is associated with one or more of: an offline or online model training during a training phase using one or more of the downlink reference signal or the virtual resource; or a model inference during an inference phase using one or more of the downlink reference signal or the virtual resource.

In a thirteenth aspect, alone or in combination with one or more of the first through twelfth aspects, the request is transmitted based at least in part on one or more of: a UE capability report that indicates types of SD, TD, and FD beam characteristics supported by the UE; or an on-demand UE request for on-demand beam characteristics.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network node, in accordance with the present disclosure. Example process 1400 is an example where the network node (e.g., network node 110) performs operations associated with requesting beam characteristics supported by a UE for a predictive beam management.

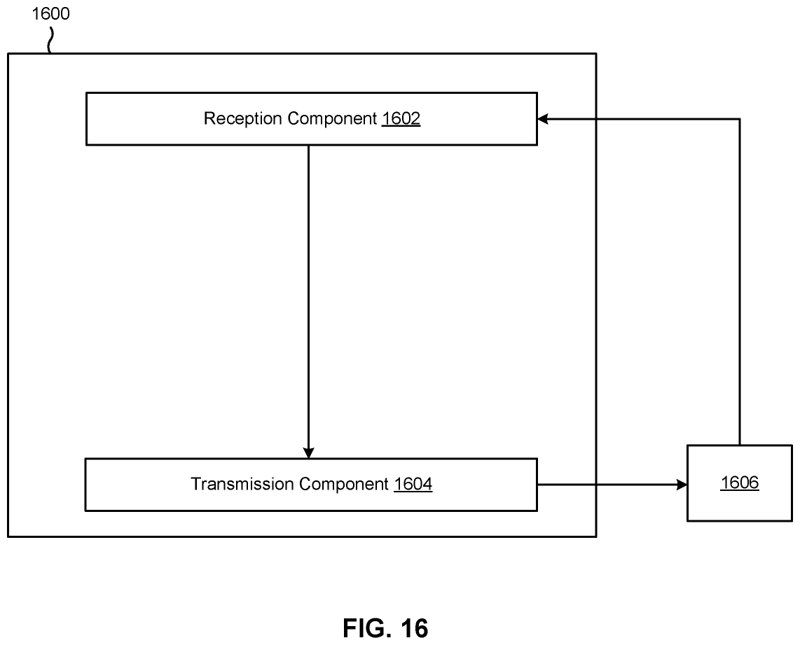

As shown in FIG. 14, in some aspects, process 1400 may include receiving, from a UE, a request that indicates one or more beam characteristics supported by the UE for a UE-based predictive beam management (block 1410). For example, the network node (e.g., using reception component 1602, depicted in FIG. 16) may receive, from a UE, a request that indicates one or more beam characteristics supported by the UE for a UE-based predictive beam management, as described above.

As further shown in FIG. 14, in some aspects, process 1400 may include transmitting, to the UE and based at least in part on the request, one or more of a downlink reference signal or an indication of a virtual resource, wherein the downlink reference signal or the virtual resource is associated with the one or more beam characteristics indicated in the request (block 1420). For example, the network node (e.g., using transmission component 1604, depicted in FIG. 16) may transmit, to the UE and based at least in part on the request, one or more of a downlink reference signal or an indication of a virtual resource, wherein the downlink reference signal or the virtual resource is associated with the one or more beam characteristics indicated in the request, as described above.

Process 1400 may include additional aspects, such as any single aspect or any combination of aspects described below and/or in connection with one or more other processes described elsewhere herein.

In a first aspect, the one or more beam characteristics include one or more of absolute beam shapes, relative beam shapes, associations among a plurality of downlink reference signals transmitted by the network node, FD occupations associated with the plurality of downlink reference signals transmitted by the network node, or TD occupations associated with the plurality of downlink reference signals transmitted by the network node.

In a second aspect, alone or in combination with the first aspect, the one or more beam characteristics include one or more of SD beam characteristics, TD beam characteristics, or FD beam characteristics.

In a third aspect, alone or in combination with one or more of the first and second aspects, the downlink reference signal is associated with an SSB resource, an NZP-CSI-RS resource, a CMR associated with a CSI report, or an IMR associated with a CSI report.

In a fourth aspect, alone or in combination with one or more of the first through third aspects, the virtual resource includes a CMR associated with a CSI report, or an IMR associated with a CSI report.

In a fifth aspect, alone or in combination with one or more of the first through fourth aspects, process 1300 includes receiving a request for a first set of downlink reference signal resources to have beam pointing directions associated with a first quantity of pointing directions and beam widths associated with a first quantity of beam widths, receiving a request for a second set of downlink reference signal resources to have beam pointing directions associated with a second quantity of pointing directions and beam widths associated with a second quantity of beam widths, and receiving a request for a third set of virtual resources to have beam pointing directions associated with a third quantity of pointing directions and beam widths associated with a third quantity of beam widths.

In a sixth aspect, alone or in combination with one or more of the first through fifth aspects, process 1300 includes receiving a request for an SD connection between different sets of resources, wherein the different sets of resources include one or more of a first set of downlink reference signal resources, a second set of downlink reference signal resources, or a third set of virtual resources, and the SD connection is one of a pointing direction connection or a beam width connection.

In a seventh aspect, alone or in combination with one or more of the first through sixth aspects, the request is associated with an actual CMR associated with a CSI report, the request is associated with an actual IMR associated with a CSI report, the request is associated with a virtual CMR associated with a CSI report, or the request is associated with a virtual IMR associated with a CSI report.

In an eighth aspect, alone or in combination with one or more of the first through seventh aspects, process 1300 includes receiving a request for a first set of downlink reference signal resources to have a periodicity equal to a first quantity of slots or a first quantity of time, receiving a request for a second set of downlink reference signal resources to have a periodicity equal to a second quantity of slots or a second quantity of time, and receiving a request for a third set of virtual resources.

In a ninth aspect, alone or in combination with one or more of the first through eighth aspects, process 1300 includes receiving a request for a TD connection between different sets of resources, wherein the different sets of resources include one or more of a first set of downlink reference signal resources, a second set of downlink reference signal resources, or a third set of virtual resources, and the TD connection is associated with a periodicity.

In a tenth aspect, alone or in combination with one or more of the first through ninth aspects, process 1300 includes receiving a request for a first set of downlink reference signal resources to have one or more of an FD density equal to a first quantity of PRBs density, a first quantity of REs per PRB, or a total quantity of occupied PRBs equal to a first quantity of PRBs, and receiving a request for a second set of downlink reference signal resources to have one or more of an FD density equal to a second quantity of PRBs density, a second quantity of REs per PRB, or a total quantity of occupied PRBs equal to a second quantity of PRBs.

In an eleventh aspect, alone or in combination with one or more of the first through tenth aspects, process 1300 includes receiving a request for an FD connection between different sets of resources, wherein the different sets of resources include a first set of downlink reference signal resources and a second set of downlink reference signal resources, and the FD connection is associated with an FD density in terms of a PRB density or a quantity of REs per PRB.

In a twelfth aspect, alone or in combination with one or more of the first through eleventh aspects, the UE-based predictive beam management is associated with one or more of: an offline or online model training during a training phase using one or more of the downlink reference signal or the virtual resource; or a model inference during an inference phase using one or more of the downlink reference signal or the virtual resource.

In a thirteenth aspect, alone or in combination with one or more of the first through twelfth aspects, the request is received based at least in part on one or more of: a UE capability report that indicates types of SD, TD, and FD beam characteristics supported by the UE; or an on-demand UE request for on-demand beam characteristics.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504.

In some aspects, the apparatus 1500 may be configured to perform one or more operations described herein in connection with FIGS. 6-12. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The transmission component 1504 may transmit, to a network node, a request that indicates one or more beam characteristics supported by the UE for a UE-based predictive beam management. The reception component 1502 may receive, from the network node and based at least in part on the request, one or more of a downlink reference signal or an indication of a virtual resource, wherein the downlink reference signal or the virtual resource is associated with the one or more beam characteristics indicated in the request.

The transmission component 1504 may transmit a request for a first set of downlink reference signal resources to have beam pointing directions associated with a first quantity of pointing directions and beam widths associated with a first quantity of beam widths. The transmission component 1504 may transmit a request for a second set of downlink reference signal resources to have beam pointing directions associated with a second quantity of pointing directions and beam widths associated with a second quantity of beam widths. The transmission component 1504 may transmit a request for a third set of virtual resources to have beam pointing directions associated with a third quantity of pointing directions and beam widths associated with a third quantity of beam widths.

The transmission component 1504 may transmit a request for an SD connection between different sets of resources, wherein the different sets of resources include one or more of: a first set of downlink reference signal resources, a second set of downlink reference signal resources, or a third set of virtual resources, and wherein the SD connection is one of a pointing direction connection or a beam width connection.

The transmission component 1504 may transmit a request for a first set of downlink reference signal resources to have a periodicity equal to a first quantity of slots or a first quantity of time. The transmission component 1504 may transmit a request for a second set of downlink reference signal resources to have a periodicity equal to a second quantity of slots or a second quantity of time. The transmission component 1504 may transmit a request for a third set of virtual resources. The transmission component 1504 may transmit a request for a TD connection between different sets of resources, wherein the different sets of resources include one or more of: a first set of downlink reference signal resources, a second set of downlink reference signal resources, or a third set of virtual resources, and wherein the TD connection is associated with a periodicity.

The transmission component 1504 may transmit a request for a first set of downlink reference signal resources to have one or more of: an FD density equal to a first quantity of PRBs density, a first quantity of REs per PRB, or a total quantity of occupied PRBs equal to a first quantity of PRBs. The transmission component 1504 may transmit a request for a second set of downlink reference signal resources to have one or more of: an FD density equal to a second quantity of PRBs density, a second quantity of REs per PRB, or a total quantity of occupied PRBs equal to a second quantity of PRBs.

The transmission component 1504 may transmit a request for an FD connection between different sets of resources, wherein the different sets of resources include a first set of downlink reference signal resources and a second set of downlink reference signal resources, and wherein the FD connection is associated with an FD density in terms of a PRB density or a quantity of REs per PRB. The transmission component 1504 may transmit the request based at least in part on one or more of: a UE capability report that indicates types of SD, TD, and FD beam characteristics supported by the UE, an on-demand UE request for on-demand beam characteristics.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network node, or a network node may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604.

In some aspects, the apparatus 1600 may be configured to perform one or more operations described herein in connection with FIGS. 6-12. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the network node described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network node described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the network node described in connection with FIG. 2. In some aspects, the transmission component 1604 may be co-located with the reception component 1602 in a transceiver.

The reception component 1602 may receive, from a UE, a request that indicates one or more beam characteristics supported by the UE for a UE-based predictive beam management. The transmission component 1604 may transmit, to the UE and based at least in part on the request, one or more of a downlink reference signal or an indication of a virtual resource, wherein the downlink reference signal or the virtual resource is associated with the one or more beam characteristics indicated in the request.

The reception component 1602 may receive a request for a first set of downlink reference signal resources to have beam pointing directions associated with a first quantity of pointing directions and beam widths associated with a first quantity of beam widths. The reception component 1602 may receive a request for a second set of downlink reference signal resources to have beam pointing directions associated with a second quantity of pointing directions and beam widths associated with a second quantity of beam widths. The reception component 1602 may receive a request for a third set of virtual resources to have beam pointing directions associated with a third quantity of pointing directions and beam widths associated with a third quantity of beam widths.

The reception component 1602 may receive a request for an SD connection between different sets of resources, wherein the different sets of resources include one or more of: a first set of downlink reference signal resources, a second set of downlink reference signal resources, or a third set of virtual resources, and wherein the SD connection is one of a pointing direction connection or a beam width connection.

The reception component 1602 may receive a request for a first set of downlink reference signal resources to have a periodicity equal to a first quantity of slots or a first quantity of time. The reception component 1602 may receive a request for a second set of downlink reference signal resources to have a periodicity equal to a second quantity of slots or a second quantity of time. The reception component 1602 may receive a request for a third set of virtual resources. The reception component 1602 may receive a request for a TD connection between different sets of resources, wherein the different sets of resources include one or more of: a first set of downlink reference signal resources, a second set of downlink reference signal resources, or a third set of virtual resources, and wherein the TD connection is associated with a periodicity.

The reception component 1602 may receive a request for a first set of downlink reference signal resources to have one or more of: an FD density equal to a first quantity of PRBs density, a first quantity of REs per PRB, or a total quantity of occupied PRBs equal to a first quantity of PRBs. The reception component 1602 may receive a request for a second set of downlink reference signal resources to have one or more of: an FD density equal to a second quantity of PRBs density, a second quantity of REs per PRB, or a total quantity of occupied PRBs equal to a second quantity of PRBs.

The reception component 1602 may receive a request for an FD connection between different sets of resources, wherein the different sets of resources include a first set of downlink reference signal resources and a second set of downlink reference signal resources, and wherein the FD connection is associated with an FD density in terms of a PRB density or a quantity of REs per PRB. The reception component 1602 may receive the request based at least in part on one or more of: a UE capability report that indicates types of SD, TD, and FD beam characteristics supported by the UE, an on-demand UE request for on-demand beam characteristics.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:
Aspect 1: A method of wireless communication performed by an apparatus of a user equipment (UE), comprising: transmitting, to a network node, a request that indicates one or more beam characteristics supported by the UE for a UE-based predictive beam management; and receiving, from the network node and based at least in part on the request, one or more of a downlink reference signal or an indication of a virtual resource, wherein the downlink reference signal or the virtual resource is associated with the one or more beam characteristics indicated in the request.
Aspect 2: The method of Aspect 1, wherein the one or more beam characteristics include one or more of: absolute beam shapes; relative beam shapes; associations among a plurality of downlink reference signals transmitted by the network node; frequency domain occupations associated with the plurality of downlink reference signals transmitted by the network node; or time domain occupations associated with the plurality of downlink reference signals transmitted by the network node.
Aspect 3: The method of any of Aspects 1 through 2, wherein the one or more beam characteristics include one or more of: spatial domain beam characteristics, time domain beam characteristics, or frequency domain beam characteristics.
Aspect 4: The method of any of Aspects 1 through 3, wherein the downlink reference signal is associated with a synchronization signal block resource, a non-zero-power channel state information reference signal resource, a channel measurement resource associated with a channel state information report, or an interference measurement resource associated with a channel state information report.
Aspect 5: The method of any of Aspects 1 through 4, wherein the virtual resource includes a channel measurement resource associated with a channel state information report, or an interference measurement resource associated with a channel state information report.
Aspect 6: The method of any of Aspects 1 through 5, wherein transmitting the request comprises: transmitting a request for a first set of downlink reference signal resources to have beam pointing directions associated with a first quantity of pointing directions and beam widths associated with a first quantity of beam widths; transmitting a request for a second set of downlink reference signal resources to have beam pointing directions associated with a second quantity of pointing directions and beam widths associated with a second quantity of beam widths; and transmitting a request for a third set of virtual resources to have beam pointing directions associated with a third quantity of pointing directions and beam widths associated with a third quantity of beam widths.
Aspect 7: The method of any of Aspects 1 through 6, wherein transmitting the request comprises: transmitting a request for a spatial domain connection between different sets of resources, wherein the different sets of resources include one or more of: a first set of downlink reference signal resources, a second set of downlink reference signal resources, or a third set of virtual resources, and wherein the spatial domain connection is one of a pointing direction connection or a beam width connection.
Aspect 8: The method of any of Aspects 1 through 7, wherein: the request is associated with an actual channel measurement resource (CMR) associated with a channel state information (CSI) report; the request is associated with an actual interference measurement resource (IMR) associated with a CSI report; the request is associated with a virtual CMR associated with a CSI report; or the request is associated with a virtual IMR associated with a CSI report.
Aspect 9: The method of any of Aspects 1 through 8, wherein transmitting the request comprises: transmitting a request for a first set of downlink reference signal resources to have a periodicity equal to a first quantity of slots or a first quantity of time; transmitting a request for a second set of downlink reference signal resources to have a periodicity equal to a second quantity of slots or a second quantity of time; and transmitting a request for a third set of virtual resources.
Aspect 10: The method of any of Aspects 1 through 9, wherein transmitting the request comprises: transmitting a request for a time domain connection between different sets of resources, wherein the different sets of resources include one or more of: a first set of downlink reference signal resources, a second set of downlink reference signal resources, or a third set of virtual resources, and wherein the time domain connection is associated with a periodicity.
Aspect 11: The method of any of Aspects 1 through 10, wherein transmitting the request comprises: transmitting a request for a first set of downlink reference signal resources to have one or more of: a frequency domain density equal to a first quantity of physical resource blocks (PRBs) density, a first quantity of resource elements (REs) per PRB, or a total quantity of occupied PRBs equal to a first quantity of PRBs; and transmitting a request for a second set of downlink reference signal resources to have one or more of: a frequency domain density equal to a second quantity of PRBs density, a second quantity of REs per PRB, or a total quantity of occupied PRBs equal to a second quantity of PRBs.
Aspect 12: The method of any of Aspects 1 through 11, wherein transmitting the request comprises: transmitting a request for a frequency domain connection between different sets of resources, wherein the different sets of resources include a first set of downlink reference signal resources and a second set of downlink reference signal resources, and wherein the frequency domain connection is associated with a frequency domain density in terms of a physical resource block (PRB) density or a quantity of resource elements per PRB.
Aspect 13: The method of any of Aspects 1 through 12, wherein the UE-based predictive beam management is associated with one or more of: an offline or online model training during a training phase using one or more of the downlink reference signal or the virtual resource; or a model inference during an inference phase using one or more of the downlink reference signal or the virtual resource.
Aspect 14: The method of any of Aspects 1 through 13, wherein the request is transmitted based at least in part on one or more of: a UE capability report that indicates types of spatial domain, time domain, and frequency domain beam characteristics supported by the UE; or an on-demand UE request for on-demand beam characteristics.
Aspect 15: A method of wireless communication performed by an apparatus of a network node, comprising: receiving, from a user equipment (UE), a request that indicates one or more beam characteristics supported by the UE for a UE-based predictive beam management; and transmitting, to the UE and based at least in part on the request, one or more of a downlink reference signal or an indication of a virtual resource, wherein the downlink reference signal or the virtual resource is associated with the one or more beam characteristics indicated in the request.
Aspect 16: An apparatus for wireless communication at a device, comprising a processor; memory coupled with the processor; and instructions stored in the memory and executable by the processor to cause the apparatus to perform the method of one or more of Aspects 1-14.
Aspect 17: A device for wireless communication, comprising a memory and one or more processors coupled to the memory, the one or more processors configured to perform the method of one or more of Aspects 1-14.
Aspect 18: An apparatus for wireless communication, comprising at least one means for performing the method of one or more of Aspects 1-14.
Aspect 19: A non-transitory computer-readable medium storing code for wireless communication, the code comprising instructions executable by a processor to perform the method of one or more of Aspects 1-14.
Aspect 20: A non-transitory computer-readable medium storing a set of instructions for wireless communication, the set of instructions comprising one or more instructions that, when executed by one or more processors of a device, cause the device to perform the method of one or more of Aspects 1-14.
Aspect 21: An apparatus for wireless communication at a device, comprising a processor; memory coupled with the processor; and instructions stored in the memory and executable by the processor to cause the apparatus to perform the method of Aspect 15.
Aspect 22: A device for wireless communication, comprising a memory and one or more processors coupled to the memory, the one or more processors configured to perform the method of Aspect 15.
Aspect 23: An apparatus for wireless communication, comprising at least one means for performing the method of Aspect 15.
Aspect 24: A non-transitory computer-readable medium storing code for wireless communication, the code comprising instructions executable by a processor to perform the method of Aspect 15.
Aspect 25: A non-transitory computer-readable medium storing a set of instructions for wireless communication, the set of instructions comprising one or more instructions that, when executed by one or more processors of a device, cause the device to perform the method of Aspect 15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, configured to:
transmit, to a network node, a request that indicates one or more beam characteristics supported by the UE for a UE-based predictive beam management; and
receive, from the network node and based at least in part on the request, one or more of a downlink reference signal or an indication of a virtual resource, wherein the downlink reference signal or the virtual resource is associated with the one or more beam characteristics indicated in the request.

2. The apparatus of claim 1, wherein the one or more beam characteristics include one or more of:
absolute beam shapes;
relative beam shapes;
associations among a plurality of downlink reference signals transmitted by the network node;
frequency domain occupations associated with the plurality of downlink reference signals transmitted by the network node; or
time domain occupations associated with the plurality of downlink reference signals transmitted by the network node.

3. The apparatus of claim 1, wherein the one or more beam characteristics include one or more of: spatial domain beam characteristics, time domain beam characteristics, or frequency domain beam characteristics.

4. The apparatus of claim 1, wherein the downlink reference signal is associated with a synchronization signal block resource, a non-zero-power channel state information reference signal resource, a channel measurement resource associated with a channel state information report, or an interference measurement resource associated with a channel state information report.

5. The apparatus of claim 1, wherein the virtual resource includes a channel measurement resource associated with a channel state information report, or an interference measurement resource associated with a channel state information report.

6. The apparatus of claim 1, wherein the one or more processors, to transmit the request, are configured to:
transmit a request for a first set of downlink reference signal resources to have beam pointing directions associated with a first quantity of pointing directions and beam widths associated with a first quantity of beam widths;
transmit a request for a second set of downlink reference signal resources to have beam pointing directions associated with a second quantity of pointing directions and beam widths associated with a second quantity of beam widths; and
transmit a request for a third set of virtual resources to have beam pointing directions associated with a third quantity of pointing directions and beam widths associated with a third quantity of beam widths.

7. The apparatus of claim 1, wherein the one or more processors, to transmit the request, are configured to:
transmit a request for a spatial domain connection between different sets of resources, wherein the different sets of resources include one or more of: a first set of downlink reference signal resources, a second set of downlink reference signal resources, or a third set of virtual resources, and wherein the spatial domain connection is one of a pointing direction connection or a beam width connection.

8. The apparatus of claim 1, wherein:
the request is associated with an actual channel measurement resource (CMR) associated with a channel state information (CSI) report;
the request is associated with an actual interference measurement resource (IMR) associated with a CSI report;
the request is associated with a virtual CMR associated with a CSI report; or
the request is associated with a virtual IMR associated with a CSI report.

9. The apparatus of claim 1, wherein the one or more processors, to transmit the request, are configured to:
transmit a request for a first set of downlink reference signal resources to have a periodicity equal to a first quantity of slots or a first quantity of time;
transmit a request for a second set of downlink reference signal resources to have a periodicity equal to a second quantity of slots or a second quantity of time; and
transmit a request for a third set of virtual resources.

10. The apparatus of claim 1, wherein the one or more processors, to transmit the request, are configured to:
transmit a request for a time domain connection between different sets of resources, wherein the different sets of resources include one or more of: a first set of downlink reference signal resources, a second set of downlink reference signal resources, or a third set of virtual resources, and wherein the time domain connection is associated with a periodicity.

11. The apparatus of claim 1, wherein the one or more processors, to transmit the request, are configured to:
transmit a request for a first set of downlink reference signal resources to have one or more of: a frequency domain density equal to a first quantity of physical resource blocks (PRBs) density, a first quantity of resource elements (REs) per PRB, or a total quantity of occupied PRBs equal to a first quantity of PRBs; and
transmit a request for a second set of downlink reference signal resources to have one or more of:
a frequency domain density equal to a second quantity of PRBs density, a second quantity of REs per PRB, or a total quantity of occupied PRBs equal to a second quantity of PRBs.

12. The apparatus of claim 1, wherein the one or more processors, to transmit the request, are configured to:
transmit a request for a frequency domain connection between different sets of resources, wherein the different sets of resources include a first set of downlink reference signal resources and a second set of downlink reference signal resources, and wherein the frequency domain connection is associated with a frequency domain density in terms of a physical resource block (PRB) density or a quantity of resource elements per PRB.

13. The apparatus of claim 1, wherein the UE-based predictive beam management is associated with one or more of:
an offline or online model training during a training phase using one or more of the downlink reference signal or the virtual resource; or
a model inference during an inference phase using one or more of the downlink reference signal or the virtual resource.

14. The apparatus of claim 1, wherein the one or more processors are configured to transmit the request based at least in part on one or more of:
a UE capability report that indicates types of spatial domain, time domain, and frequency domain beam characteristics supported by the UE; or
an on-demand UE request for on-demand beam characteristics.

15. An apparatus for wireless communication at a network node, comprising:
a memory; and
one or more processors, coupled to the memory, configured to:
receive, from a user equipment (UE), a request that indicates one or more beam characteristics supported by the UE for a UE-based predictive beam management; and
transmit, to the UE and based at least in part on the request, one or more of a downlink reference signal or an indication of a virtual resource, wherein the downlink reference signal or the virtual resource is associated with the one or more beam characteristics indicated in the request.

16. A method of wireless communication performed by an apparatus of a user equipment (UE), comprising:
transmitting, to a network node, a request that indicates one or more beam characteristics supported by the UE for a UE-based predictive beam management; and
receiving, from the network node and based at least in part on the request, one or more of a downlink reference signal or an indication of a virtual resource, wherein the downlink reference signal or the virtual resource is associated with the one or more beam characteristics indicated in the request.

17. The method of claim 16, wherein the one or more beam characteristics include one or more of:
absolute beam shapes;
relative beam shapes;
associations among a plurality of downlink reference signals transmitted by the network node;
frequency domain occupations associated with the plurality of downlink reference signals transmitted by the network node; or
time domain occupations associated with the plurality of downlink reference signals transmitted by the network node.

18. The method of claim 16, wherein the one or more beam characteristics include one or more of: spatial domain beam characteristics, time domain beam characteristics, or frequency domain beam characteristics.

19. The method of claim 16, wherein the downlink reference signal is associated with a synchronization signal block resource, a non-zero-power channel state information reference signal resource, a channel measurement resource associated with a channel state information report, or an interference measurement resource associated with a channel state information report.

20. The method of claim 16, wherein the virtual resource includes a channel measurement resource associated with a channel state information report, or an interference measurement resource associated with a channel state information report.

21-30. (canceled)
